(19) United States
(12) Patent Application Publication
(10) Pub. No.: US 2026/0227597 A1
(43) Pub. Date: Aug. 6, 2026

(54) LENS OPTICAL SYSTEM AND IMAGING APPARATUS

(71) Applicant: SONY GROUP CORPORATION, TOKYO (JP)

(72) Inventors: HIDENORI NAGASAKA, TOKYO (JP); SATOSHI TAKEMOTO, TOKYO (JP)

(21) Appl. No.: 19/153,993

(22) PCT Filed: Feb. 15, 2024
(86) PCT No.: PCT/JP2024/005159

§ 371 Date: Aug. 6, 2025

(30) Foreign Application Priority Data
Feb. 27, 2023 (JP) 2023-028426

(51) Int. Cl. G02B 9/62

(52) U.S. Cl. CPC G02B 9/62

(57) ABSTRACT

The present technology relates to a lens optical system and an imaging apparatus that can realize both good imaging quality and a small F-number in a small size and a wide angle. The lens optical system includes a first lens group having negative refractive power and a second lens group having positive refractive power in order from the object side toward the image side. The first lens group includes a first lens having negative refractive power. The second lens group includes, in order from the object side to the image side, a second lens having positive refractive power, a third lens having negative refractive power, a fourth lens having positive or negative refractive power, a fifth lens having positive refractive power, and a sixth lens having negative refractive power. When a focal length of the entire lens optical system is f and a focal length of the second lens group is fa2, the lens optical system satisfies a condition of 1≤fa2/f≤2. The present technology can be applied to, for example, a lens optical system and the like.

### TECHNICAL FIELD

The present technology relates to a lens optical system and an imaging apparatus, and more particularly to a lens optical system and an imaging apparatus that can realize both good imaging quality and a small F-number in a small size and wide angle.

### BACKGROUND ART

With the development of imaging technologies, imaging lenses have been widely applied to various electronic devices such as smartphones and digital cameras. These electronic devices are required to be reduced in weight and thickness from the viewpoint of portability convenience. Therefore, small imaging lenses having good imaging quality have already become mainstream in the current market.

In recent years, imaging lenses for a plurality of applications have been mounted on smartphones, and there is an increasing demand for ultra-wide-angle imaging lenses. However, in the imaging lens, when the angle is widened with a short optical overall length, it is very difficult to correct the aberration. Therefore, the F-number tends to be large (dark) in order to improve the imaging quality (resolution performance) of the imaging lens. In a case where the F-number of the lens optical system is small (bright), the imaging quality is deteriorated.

Meanwhile, there is an imaging lens that achieves a wide angle while performing good aberration correction with five lenses (see, for example, Patent Document 1). However, in this imaging lens, since power is used for aberration correction, the F-number is large.

### CITATION LIST

### Patent Document

Patent Document 1: Japanese Patent Application Laid-Open No. 2022-044532

### SUMMARY OF THE INVENTION

### Problems to be Solved by the Invention

As described above, in a lens optical system such as an imaging lens, there is a demand for a method for achieving both good imaging quality and a small F-number in a small size and wide angle. However, such a demand has not been sufficiently met.

The present technology has been made in view of such a situation, and an object thereof is to realize both good imaging quality and a small F-number in a compact and wide angle lens optical system.

### Solutions to Problems

A lens optical system according to a first aspect of the present technology is a lens optical system including: in order from an object side toward an image side, a first lens group having negative refractive power; and a second lens group having positive refractive power, in which the first lens group includes a first lens with negative refractive power, the second lens group includes: in order from the object side toward the image side, a second lens having positive refractive power; a third lens having negative refractive power; a fourth lens having positive or negative refractive power; a fifth lens having positive refractive power; and a sixth lens having negative refractive power, and when a focal length of the entire lens optical system is f and a focal length of the second lens group is fa2, a condition of 1≤fa2/f≤2 is satisfied.

In the first aspect of the present technology, a first lens group having negative refractive power and a second lens group having positive refractive power are provided in order from the object side toward the image side. The first lens group includes a first lens having negative refractive power. The second lens group includes, in order from the object side to the image side, a second lens having positive refractive power, a third lens having negative refractive power, a fourth lens having positive or negative refractive power, a fifth lens having positive refractive power, and a sixth lens having negative refractive power. When a focal length of the entire lens optical system is f and a focal length of the second lens group is fa2, a condition of 1≤fa2/f≤2 is satisfied.

An imaging apparatus according to a second aspect of the present technology includes: a lens optical system including: in order from an object side toward an image side, a first lens group having negative refractive power; and a second lens group having positive refractive power, in which the first lens group includes a first lens with negative refractive power, the second lens group includes: in order from the object side toward the image side, a second lens having positive refractive power; a third lens having negative refractive power; a fourth lens having positive or negative refractive power; a fifth lens having positive refractive power; and a sixth lens having negative refractive power, and when a focal length of the entire lens optical system is f and a focal length of the second lens group is fa2, a condition of 1≤fa2/f≤2 is satisfied; and an imaging element that converts an optical image formed by the lens optical system into an electrical signal.

In the second aspect of the present technology, provided are: a lens optical system including: in order from an object side toward an image side, a first lens group having negative refractive power; and a second lens group having positive refractive power, in which the first lens group includes a first lens with negative refractive power, the second lens group includes: in order from the object side toward the image side, a second lens having positive refractive power; a third lens having negative refractive power; a fourth lens having positive or negative refractive power; a fifth lens having positive refractive power; and a sixth lens having negative refractive power, and when a focal length of the entire lens optical system is f and a focal length of the second lens group is fa2, a condition of 1≤fa2/f≤2 is satisfied; and an imaging element that converts an optical image formed by the lens optical system into an electrical signal.

### BRIEF DESCRIPTION OF DRAWINGS

FIG. 1 is a cross-sectional view illustrating a configuration example of an embodiment of an imaging apparatus to which the present technology is applied.

FIG. 2 is a cross-sectional view illustrating a first configuration example of the lens optical system.

FIG. 3 is a table illustrating setting data of the lens and the IR cut filter of FIG. 2.

FIG. 4 is a table illustrating aspherical data of the surface of FIG. 2.

FIG. 5 is a graph illustrating spherical aberration, field curvature, and distortion aberration in the lens optical system of FIG. 2.

FIG. 6 is a cross-sectional view illustrating a second configuration example of the lens optical system.

FIG. 7 is a table illustrating setting data of the lens and the IR cut filter of FIG. 6.

FIG. 8 is a table illustrating aspherical data of the surface of FIG. 6.

FIG. 9 is a graph illustrating spherical aberration, field curvature, and distortion aberration in the lens optical system of FIG. 6.

FIG. 10 is a cross-sectional view illustrating a third configuration example of the lens optical system.

FIG. 11 is a table illustrating setting data of the lens and the IR cut filter of FIG. 10.

FIG. 12 is a table illustrating aspherical data of the surface of FIG. 10.

FIG. 13 is a graph illustrating spherical aberration, field curvature, and distortion aberration in the lens optical system of FIG. 10.

FIG. 14 is a cross-sectional view illustrating a fourth configuration example of the lens optical system.

FIG. 15 is a table illustrating setting data of the lens and the IR cut filter of FIG. 14.

FIG. 16 is a table illustrating aspherical data of the surface of FIG. 14.

FIG. 17 is a graph illustrating spherical aberration, field curvature, and distortion aberration in the lens optical system of FIG. 14.

FIG. 18 is a cross-sectional view illustrating a fifth configuration example of the lens optical system.

FIG. 19 is a table illustrating setting data of the lens and the IR cut filter of FIG. 18.

FIG. 20 is a table illustrating aspherical data of the surface of FIG. 18.

FIG. 21 is a graph illustrating spherical aberration, field curvature, and distortion aberration in the lens optical system of FIG. 18.

FIG. 22 is a table illustrating values of parameters or formulas in the lens optical system.

FIG. 23 is a block diagram illustrating a hardware configuration example of a smartphone as an electronic device to which the present technology is applied.

FIG. 24 is a diagram for explaining a usage example of the imaging apparatus.

FIG. 25 is a view depicting an example of a schematic configuration of an endoscopic surgery system.

FIG. 26 is a block diagram depicting an example of a functional configuration of a camera head and a camera control unit (CCU).

FIG. 27 is a block diagram depicting an example of schematic configuration of a vehicle control system.

FIG. 28 is an explanatory diagram illustrating an example of an installation position of an imaging section.

### MODE FOR CARRYING OUT THE INVENTION

Modes for carrying out the present technology (hereinafter, referred to as embodiments) will be described below. Note that the description will be given in the following order.
1. One Embodiment (Imaging Apparatus)
2. Application Example to Electronic Device
3. Usage Example of Imaging Apparatus
4. Application Example to Endoscopic Surgery System
5. Application Example to Mobile Body

Note that, in the drawings referred to in the following description, the same or similar parts are denoted by the same or similar reference signs. However, the drawings are schematic, and the relationship between the thickness and the plane dimension, the ratio of the thickness of each layer, and the like are different from the actual ones. In addition, the drawings may include portions having different dimensional relationships and ratios.

In addition, the definitions of directions such as up and down in the following description are merely definitions for convenience of description, and do not limit the technical idea of the present disclosure. For example, when an object is observed by rotating the object by 90°, the upper and lower sides are converted into left and right and read, and when the object is observed by rotating the object by 180°, the upper and lower sides are inverted and read.

### 1. One Embodiment

### <Configuration Example of Imaging Apparatus>

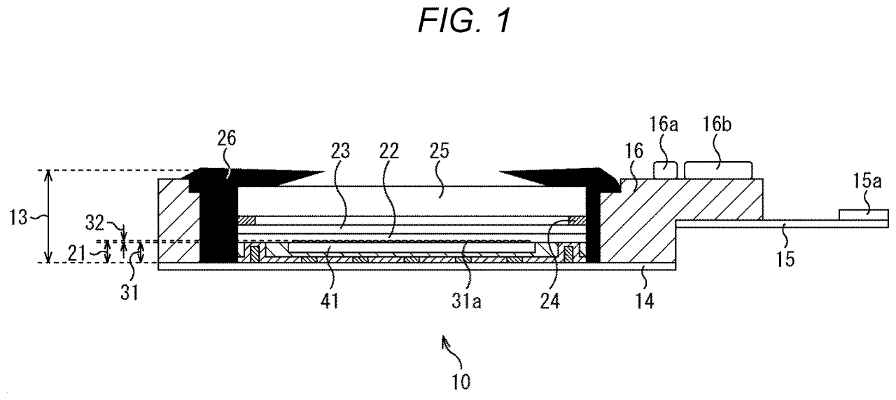

FIG. 1 is a cross-sectional view illustrating a configuration example of an embodiment of an imaging apparatus to which the present technology is applied.

An imaging apparatus 10 in FIG. 1 includes a thin circuit board 14 on which a solid-state imaging apparatus 13 is installed, a circuit board 15, and a spacer 16.

The solid-state imaging apparatus 13 has a chip size package (CSP) structure. The CSP structure is one of the structures of the solid-state imaging apparatus that realizes a large number of pixels, a small size, and a low height, and is an extremely small package structure realized in substantially the same size as the single chip. The solid-state imaging apparatus 13 includes a solid-state imaging element 21, an adhesive 22, a glass substrate 23, a black resin 24, a lens optical system 25, and a fixing agent 26.

The solid-state imaging element 21 is a CCD sensor or a CMOS image sensor, and includes a semiconductor substrate 31 and an on-chip lens 32. The lower surface of the semiconductor substrate 31 in FIG. 1 is connected to the circuit board 14. On an imaging surface 31a that is a partial region of the upper surface of the semiconductor substrate 31 in FIG. 1, a pixel array 41 and the like including light receiving elements corresponding to a plurality of pixels arranged in a two-dimensional lattice shape are formed. The on-chip lens 32 is formed at a position corresponding to each pixel on the pixel array 41.

The adhesive 22 is a transparent adhesive provided on the upper surface in FIG. 1 including the imaging surface 31a of the solid-state imaging element 21. The glass substrate 23 is bonded to the solid-state imaging element 21 via the adhesive 22 for the purpose of fixing the solid-state imaging element 21, protecting the imaging surface 31a, and the like.

The black resin 24 is formed on a surface of the glass substrate 23 opposite to the bonding surface of the adhesive 22, and has a function of a spacer. An infrared (IR) cut filter (not illustrated) of the lens optical system 25 is installed on the glass substrate 23 via the black resin 24 so as to be parallel to the glass substrate 23. As a result, the glass substrate 23 is disposed between the lens optical system 25 and the imaging surface 31a. The black resin 24 (black mask) shields light outside the imaging surface 31a among light incident through the lens optical system 25.

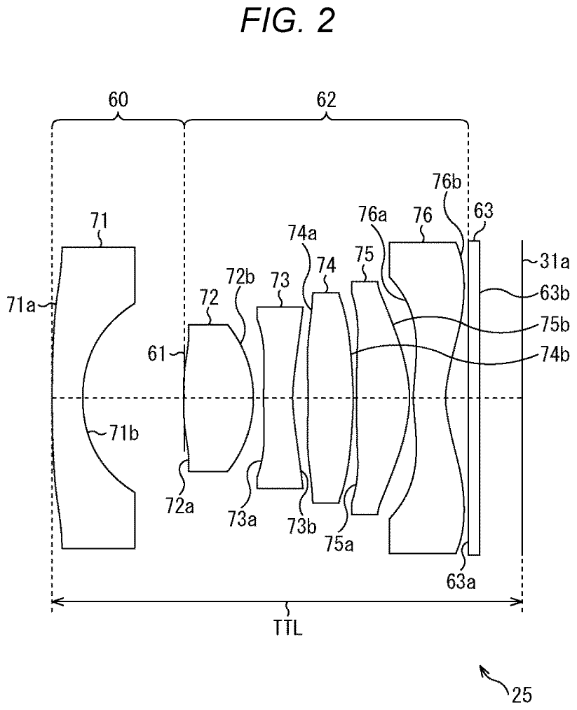

The lens optical system 25 is a lens optical system that condenses light from a subject and forms an optical image on the imaging surface 31a. The configuration of the lens optical system 25 will be described in detail with reference to FIGS. 2, 6, 10, 14, and 18 to be described later.

The fixing agent 26 is applied to the side surfaces of the solid-state imaging element 21, the adhesive 22, the glass substrate 23, the black resin 24, and the lens optical system 25, and the periphery of a surface (upper surface in FIG. 1) on the object side (light incident side) of the lens optical system 25. The fixing agent 26 fixes the solid-state imaging element 21, the adhesive 22, the glass substrate 23, the black resin 24, and the lens optical system 25. The fixing agent 26 can reduce light incident from the side surface of the solid-state imaging apparatus 13 and refracted or reflected. Furthermore, the fixing agent 26 can shield light incident on the solid-state imaging apparatus 13 from the periphery of the region corresponding to the imaging surface 31a.

Light from the subject enters the imaging surface 31a via the lens optical system 25, the glass substrate 23, the adhesive 22, and the on-chip lens 32, whereby an optical image is formed on the imaging surface 31a. Each light receiving element of the pixel array 41 performs imaging by converting the optical image into an electric signal.

As described above, since the lens optical system 25 is included in the CSP structure of the solid-state imaging apparatus 13, the imaging apparatus 10 can be downsized as compared with a case where the lens optical system 25 is provided separately.

The circuit board 14 is a circuit board that is connected to the lower surface of the semiconductor substrate 31 in FIG. 1 and outputs a camera signal corresponding to an electric signal generated by each light receiving element to the spacer 16.

The circuit board 15 is a circuit board for outputting a camera signal output from the circuit board 14 via the spacer 16 to the outside, and electronic components and the like are mounted on the circuit board. The circuit board 15 has a connector 15a for connection with an external apparatus, and outputs a camera signal to the external apparatus.

The spacer 16 is a circuit built-in spacer for fixing an actuator (not illustrated) that drives the lens optical system 25 and the circuit board 15. Semiconductor components 16a and 16b and the like are mounted on the spacer 16. The semiconductor components 16a and 16b are a capacitor, a semiconductor component constituting a large scale integration (LSI) that controls an actuator (not illustrated) that drives the lens optical system 25, and the like. The spacer 16 outputs the camera signal output from the circuit board 14 to the circuit board 15.

### <First Configuration Example of Lens Optical System>

FIG. 2 is a cross-sectional view illustrating a first configuration example of the lens optical system 25.

As illustrated in FIG. 2, the lens optical system 25 includes a lens group 60 (first lens), an aperture diaphragm 61, a lens group 62 (second lens), and an IR cut filter 63 in order from the object side toward the image side (light emission side).

The lens group 60 closer to the object side than the aperture diaphragm 61 includes a lens 71 (first lens) having negative refractive power, and has negative refractive power. The lens 71 has a surface 71a on the object side (left side in FIG. 2) and a surface 71b on the image side (right side in FIG. 2). The shape of the lens 71 is a biconcave shape in which the surface 71b is a concave surface in the vicinity of the optical axis. As a result, the light beam can be incident from a wide angle, and the angle of the light beam incident on the lens group 62 from the lens 71 can be set to an appropriate angle. Note that the shape of the lens 71 may not be a biconcave shape as long as the surface 71b is a concave surface in the vicinity of the optical axis. For example, the shape of the lens 71 may be a plano-concave shape in which the surface 71a is a flat surface and the surface 71b is a concave surface in the vicinity of the optical axis.

The aperture diaphragm 61 restricts light incident on the lens group 60 from the lens group 62.

The lens group 62 closer to the image side than the aperture diaphragm 61 has positive refractive power. The lens group 62 includes a lens 72 (second lens), a lens 73 (third lens), a lens 74 (fourth lens), a lens 75 (fifth lens), and a lens 76 (sixth lens) in order from the object side to the image side.

The lens 72 has an object-side surface 72a and an image-side surface 72b, and has positive refractive power. The shape of the lens 72 is a biconvex shape in which the surface 72a and the surface 72b are convex surfaces in the vicinity of the optical axis. Thus, the height of the lens optical system 25 can be reduced.

The lens 73 has an object-side surface 73a and an image-side surface 73b, and has negative refractive power. The shape of the lens 73 is a meniscus shape in which the surface 73b is a concave surface in the vicinity of the optical axis. The lens 73 corrects spherical aberration, coma aberration, and chromatic aberration generated in the lens 71 and the lens 72. The shape of the lens 73 may not be a meniscus shape as long as the surface 73b is a concave surface. For example, the shape of the lens 73 may be a plano-concave shape in which the surface 73a is a flat surface in the vicinity of the optical axis.

The lens 74 has an object-side surface 74a and an image-side surface 74b, and has positive refractive power. The lens 74 has an uneven shape in which the surface 74a is a concave surface and the surface 74b is a convex surface in the vicinity of the optical axis. By appropriately balancing the refractive power of the lens 72 and the lens 74, it is possible to correct astigmatism while reducing the height of the lens optical system 25. Note that the shape of the lens 74 may not be an uneven shape as long as the surface 74b is a convex surface in the vicinity of the optical axis. For example, the shape of the lens 74 may be a biconvex shape in which both surfaces 74a and 74b are convex surfaces in the vicinity of the optical axis.

The lens 75 has an object-side surface 75a and an image-side surface 75b, and has positive refractive power. The shape of the lens 75 is a biconvex shape in which the surface 75a and the surface 75b are convex surfaces in the vicinity of the optical axis. The lens 75 controls an incident angle of a light beam reaching the imaging surface 31a and satisfactorily corrects astigmatism.

The lens 76 has an object-side surface 76a and an image-side surface 76b, and has negative refractive power. The shape of the lens 76 is a meniscus shape in which the surface 76a is a convex surface in the vicinity of the optical axis. Both surfaces 76a and 76b have an aspherical shape. The aspherical shape of the surface 76b has a peak point, whereby the shape of the surface 76b changes to a convex shape at a peripheral portion that is a portion away from the optical axis. Since the surfaces 76a and 76b have an aspherical shape as described above, the lens 76 can control the incident angle of the light beam reaching the imaging surface 31a and can satisfactorily correct field curvature, astigmatism, and distortion aberration.

The IR cut filter 63 transmits light other than infrared light among the light incident from the object-side surface 63a and emits the light from the image-side surface 63b. Note that the IR cut filter 63 may not be provided, or a cover glass or the like may be provided instead of the IR cut filter 63.

The light incident on the lens optical system 25 from the subject (object) is emitted via the surfaces 71a, 71b, 72a, 72b, 73a, 73b, 74a, 74b, 75a, 75b, 76a, 76b, 63a, and 63b. The light emitted from the lens optical system 25 in this manner is condensed on the imaging surface 31a via the glass substrate 23, the adhesive 22, and the on-chip lens 32. Note that the total length TTL of the lens optical system 25 in FIG. 2 is a distance on the optical axis between the surface 71a and the imaging surface 31a.

In FIG. 2, only the imaging surface 31a is illustrated in order to simplify the drawing, but actually, the glass substrate 23, the adhesive 22, and the on-chip lens 32 exist between the lens optical system 25 and the imaging surface 31a. It similarly applies to FIGS. 2, 6, 10, 14, and 18 described later.

### <First Example of Setting Data of Each Lens and IR Cut Filter>

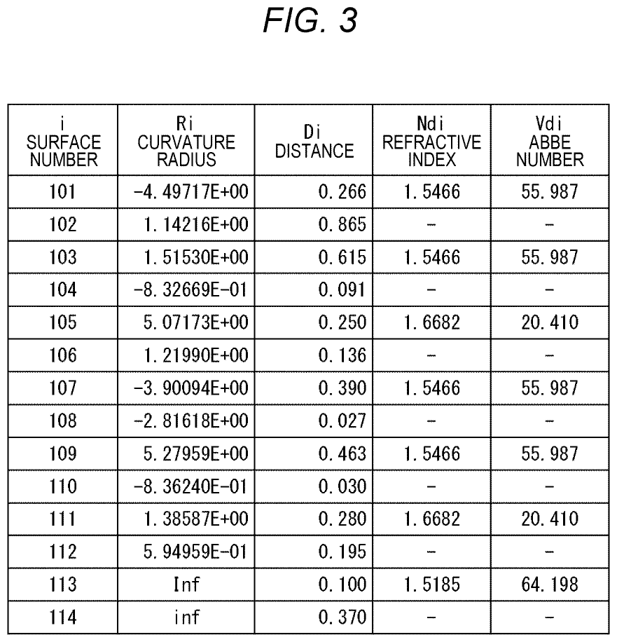

FIG. 3 is a table illustrating setting data of the lenses 71 to 76 and the IR cut filter 63.

Each row in the table of FIG. 3 corresponds to each of the surfaces 63a and 63b, the surfaces 71a to 76a, and the surfaces 71b to 76b. Each row corresponds to, in order from the left side, a surface number i, a curvature radius Ri, a surface distance Di which is a distance on the optical axis with the surface of the next surface number i+1, a refractive index Ndi with respect to the d-line (wavelength 587.6 nm), and an Abbe number Vdi at the d-line.

The surface number is a number given to each surface of the lens optical system 25. In the present specification, it is assumed that surface numbers from 101 to 114 are sequentially assigned to surfaces 71a, 71b, 72a, 72b, 73a, 73b, 74a, 74b, 75a, 75b, 76a, 76b, 63a, and 63b.

As illustrated in FIG. 3, the curvature radius R101 of the surface 71a having the surface number i of 101 is −4.49717, the surface distance D101 from the surface 71b having the surface number i of 102 is 0.266, and the refractive index Nd101 is 1.5466. The Abbe number Vd101 of the surface 71a, that is, the Abbe number V101 of the lens 71 is 55.987. The curvature radius R102 of the surface 71b having the surface number i of 102 is 1.14216, and the surface distance D102 from the surface of the surface 72a having the surface number i of 103 is 0.865.

The curvature radius R103 of the surface 72a having the surface number i of 103 is 1.51530, the surface distance D103 from the surface 72b having the surface number i of 104 is 0.615, and the refractive index Nd103 is 1.5466. The Abbe number Vd103 of the surface 72a, that is, the Abbe number V102 of the lens 72 is 55.987. The curvature radius R104 of the surface 72b having the surface number i of 104 is −8.32669×10⁻¹, and the surface distance D104 from the surface 73a having the surface number i of 105 is 0.091.

The curvature radius R105 of the surface 73a having the surface number i of 105 is 5.07173, the surface distance D105 from the surface 73b having the surface number i of 106 is 0.250, and the refractive index Nd105 is 1.6682. The Abbe number Vd105 of the surface 73a, that is, the Abbe number V103 of the lens 73 is 20.410. The curvature radius R106 of the surface 73b having the surface number i of 106 is 1.21990, and the surface distance D106 from the surface 74a having the surface number i of 107 is 0.136.

The curvature radius R107 of the surface 74a having the surface number i of 107 is −3.90094, the surface distance D107 from the surface 74b having the surface number i of 108 is 0.390, and the refractive index Nd107 is 1.5466. The Abbe number Vd107 of the surface 74a, that is, the Abbe number V104 of the lens 74 is 55.987. The curvature radius R108 of the surface 74b having the surface number i of 108 is −2.81618, and the surface distance D108 from the surface 75a having the surface number i of 109 is 0.027.

The curvature radius R109 of the surface 75a having the surface number i of 109 is 5.27959, the surface distance D109 from the surface 75b having the surface number i of 110 is 0.463, and the refractive index Nd109 is 1.5466. The Abbe number Vd109 of the surface 75a, that is, the Abbe number V105 of the lens 75 is 55.987. The curvature radius R110 of the surface 75b having the surface number i of 110 is −8.36240×10⁻¹, and the surface distance D110 from the surface 76a having the surface number i of 111 is 0.030.

The curvature radius R111 of the surface 76a having the surface number i of 111 is 1.38587, the surface distance D111 from the surface 76b having the surface number i of 112 is 0.280, and the refractive index Nd111 is 1.6682. The Abbe number Vd111 of the surface 76a, that is, the Abbe number V106 of the lens 76 is 20.410. The curvature radius R112 of the surface 76b having the surface number i of 112 is 5.94959×10⁻¹, and the surface distance D112 from the surface 63a having the surface number i of 113 is 0.195.

The curvature radius R113 of the surface 63a having the surface number i of 113 is infinite, the surface distance D113 from the surface 63b having the surface number i of 114 is 0.110, and the refractive index Nd113 is 1.5185. The Abbe number Vd113 of the surface 63a, that is, the Abbe number V107 of the IR cut filter 63 is 64.198. The curvature radius R114 of the surface 63b having the surface number i of 114 is infinite, and the surface distance D114 from the imaging surface 31a is 0.370.

### <First Example of Aspherical Data of Each Surface>

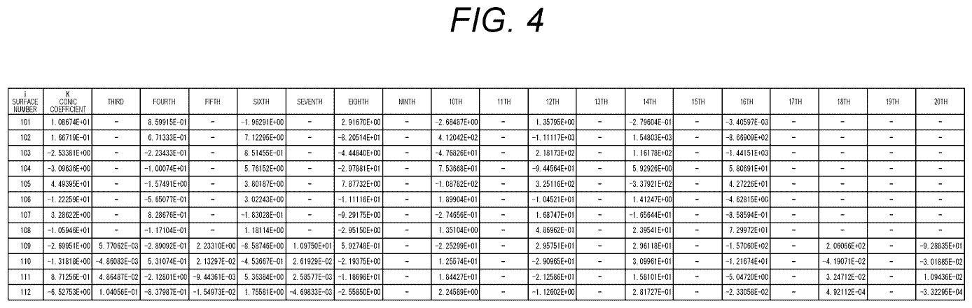

FIG. 4 is a table illustrating aspherical data of the surfaces 71a to 76a and the surfaces 71b to 76b.

Each row in the table of FIG. 4 corresponds to each of the surfaces 71a to 76a and the surfaces 71b to 76b. Each column corresponds to a surface number i, a conic coefficient K, and a third order aspheric coefficient to a 20th order aspheric coefficient in order from the left side.

As illustrated in FIG. 4, the conic coefficient K of the surface 71a having the surface number i of 101 is 1.08674×10. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are 8.5991×10⁻¹, −1.96291, 2.91670, −2.68487, 1.35795, −2.79604×10⁻¹, and −3.40597−10⁻³, respectively.

The conic coefficient K of the surface 71b having the surface number i of 102 is 1.66719×10⁻¹. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are 6.71333×10⁻¹, 7.12295, −8.20514×10, 4.12042×10², −1.11117×10³, 1, 54803×10³, and −8.66909×10², respectively.

The conic coefficient K of the surface of the surface 72a having the surface number i of 103 is −2.53381. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are −2.23433×10⁻¹, 8.51455×10⁻¹, −4.44840, −4.76826×10, 2.18173×10², 1.16178×10², and −1.44151×10³, respectively.

The conic coefficient K of the surface 72b having the surface number i of 104 is −3.09636. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are −1.00074, 5.76152, −2.97881×10, 7.53668×10, −9.44564×10, 5.92926, and 5.80691×10, respectively.

The conic coefficient K of the surface 73a having the surface number i of 105 is 4.49395×10. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are −1.57491, 3.80187, 7.87732, −1.08782×10², 3.25116×10², −3.37921×10², and 4.27226×10, respectively.

The conic coefficient K of the surface 73b having the surface number i of 106 is −1.22259×10. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are −5.65077×10⁻¹, 3.02243, −1.11116×10, 1.89904×10, −1.04521×10, 1.41247, and −4.62815, respectively.

The conic coefficient K of the surface 74a having the surface number i of 107 is 3.28662. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are 8.28676×10⁻¹, −1.83028×10⁻¹, −3.29175, −2.74656×10⁻¹, 1.68747×10, −1.65644×10, and −8.58594×10⁻¹, respectively.

The conic coefficient K of the surface 74b having the surface number i of 108 is −1.05946×10. The fourth order aspheric coefficient, the sixth order aspheric coefficient, the eighth order aspheric coefficient, the 10th order aspheric coefficient, the 12th order aspheric coefficient, the 14th order aspheric coefficient, and the 16th order aspheric coefficient are −1.17104×10⁻¹, 1.18114, −2.95150, 1.35104, 4.86862×10⁻¹, 2.39541×10⁻¹, and 7.29972×10⁻¹, respectively.

The conic coefficient K of the surface 75a having the surface number i of 109 is −2.69951. The third order aspheric coefficient to the eighth order aspheric coefficient are 5.77062×10⁻³, −2.89092×10⁻¹, 2.23310, −8.58746, 1.09750×10, and 5.92748×10⁻¹, respectively. The 10th order aspheric coefficient, the 12th order aspheric coefficient, the 14th order aspheric coefficient, the 16th order aspheric coefficient, the 18th order aspheric coefficient, and the 20th order aspheric coefficient are −2.25299×10, 2.95751×10, 2.96118×10, 1.57060×10², 2.06066×10², and −9.28835×10, respectively.

The conic coefficient K of the surface 75b having the surface number i of 110 is −1.31818. The third order aspheric coefficient to the eighth order aspheric coefficient are −4.86083×10⁻³, 5.31074×10⁻¹, 2.13297×10⁻², −4.53667×10⁻¹, 2.61929×10⁻², and −2.19375, respectively. The 10th order aspheric coefficient, the 12th order aspheric coefficient, the 14th order aspheric coefficient, the 16th order aspheric coefficient, the 18th order aspheric coefficient, and the 20th order aspheric coefficient are 1.25574×10, −2.90965×10, 3.09961×10, −1.21674×10, −4.19071×10⁻², and −3.01885×10⁻², respectively.

The conic coefficient K of the surface 76a having the surface number i of 111 is 6.71256×10⁻¹. The third order aspheric coefficient to the eighth order aspheric coefficient are 4.86467×10⁻², −2.12801, −9.44361×10⁻³, 5.36384, 2.58577×10⁻³, and −1.18698×10, respectively. The 10th order aspheric coefficient, the 12th order aspheric coefficient, the 14th order aspheric coefficient, the 16th order aspheric coefficient, the 18th order aspheric coefficient, and the 20th order aspheric coefficient are 1.84427×10, −2.12585×10, 1.56101×10, −5.04720, 3.24712×10⁻², and 1.09436×10⁻², respectively.

The conic coefficient K of the surface 76b having the surface number i of 112 is −6.52753. The third order aspheric coefficient to the eighth order aspheric coefficient are −1.04056×10⁻¹, −8.37987×10⁻¹, −1.54973×10⁻², 1.75581, −4.69833×10⁻³, and −2.55850, respectively. The 10th order aspheric coefficient, the 12th order aspheric coefficient, the 14th order aspheric coefficient, the 16th order aspheric coefficient, the 18th order aspheric coefficient, and the 20th order aspheric coefficient are 2.24589, −1.12602, 2.81727×10⁻¹, −2.33058×10⁻², 4.92112×10⁻⁴, and −3.32295×10⁻⁴, respectively.

### <First Example of Spherical Aberration, Field Curvature, and Distortion Aberration>

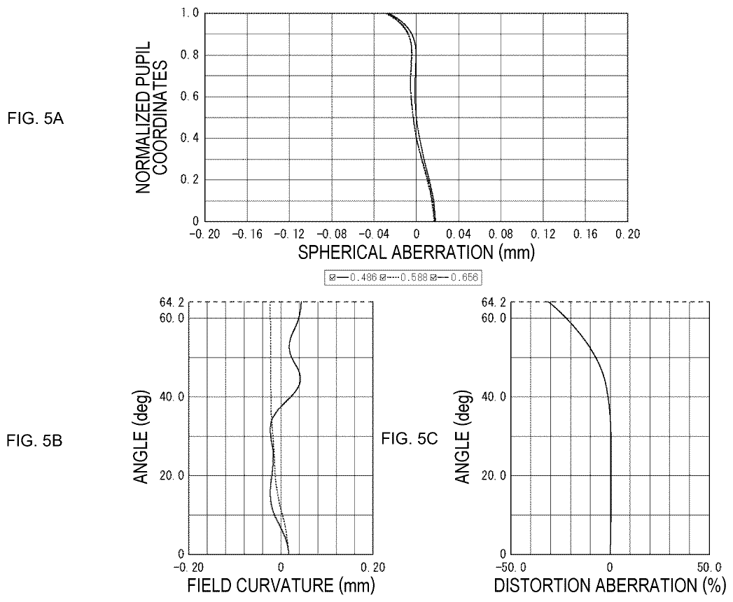

FIG. 5 is a graph illustrating spherical aberration, field curvature, and distortion aberration generated in the lens optical system 25 in FIG. 2.

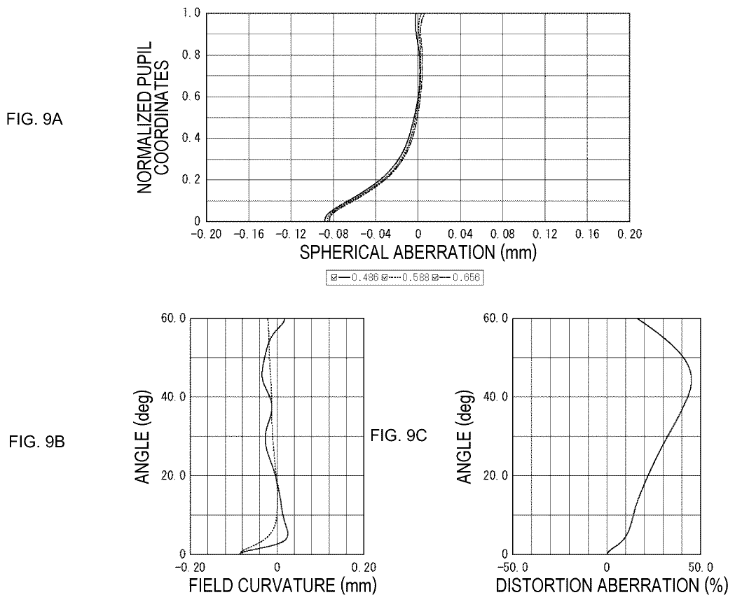

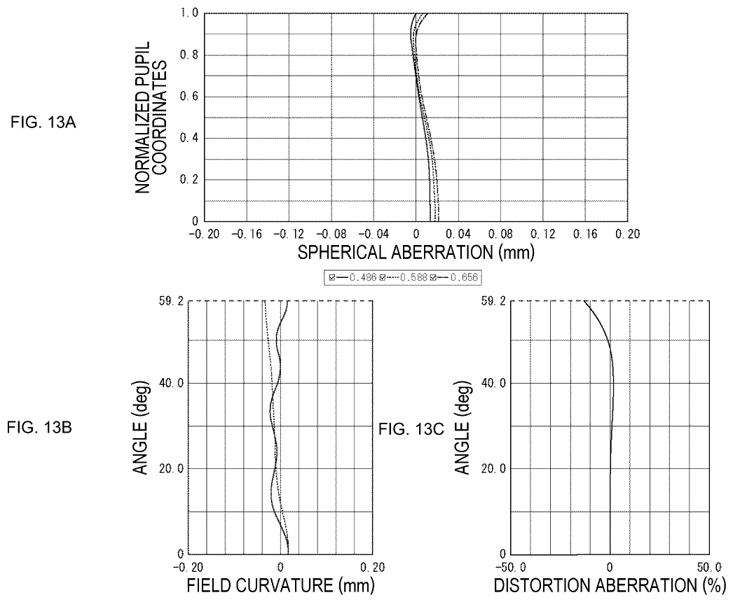

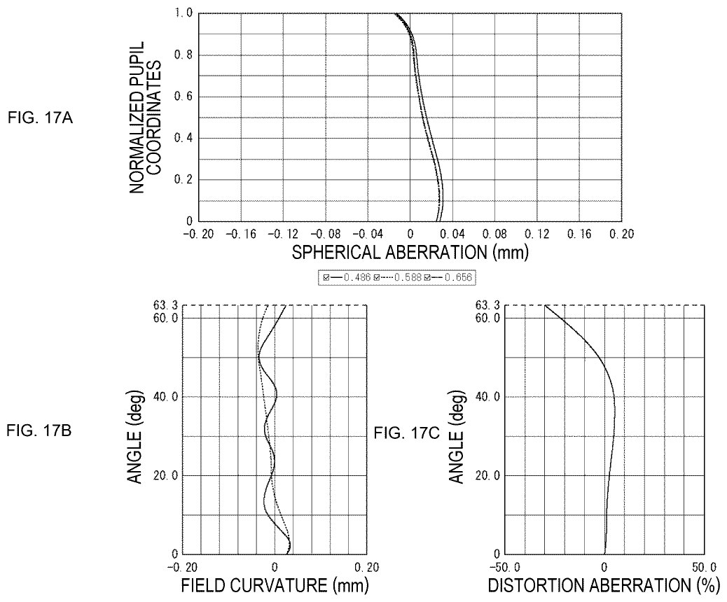

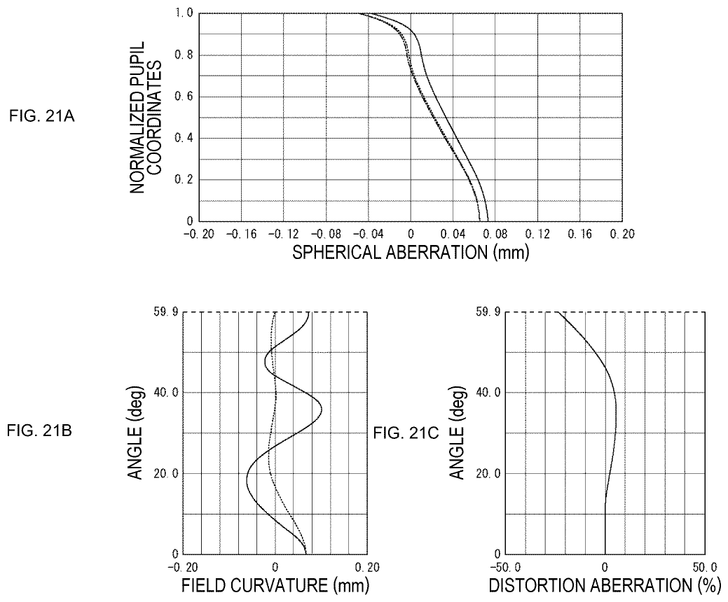

A of FIG. 5 is a graph illustrating spherical aberration in the longitudinal direction for each wavelength of light having wavelengths of 0.486 mm, 0.588 mm, and 0.656 mm, which occurs in the lens optical system 25 of FIG. 2. In the graph in A of FIG. 5, the horizontal axis represents spherical aberration [mm], and the vertical axis represents normalized pupil coordinates. It similarly applies to A of FIG. 9, A of FIG. 13, A of FIG. 17, and A of FIG. 21 to be described later. In A of FIG. 5, the pupil radius is 0.2641 mm.

B of FIG. 5 is a graph illustrating field curvature of light having a wavelength of 0.546 mm generated in the lens optical system 25 of FIG. 2. In the graph of B of FIG. 5, the horizontal axis represents the field curvature [mm], and the vertical axis represents the angle [degree] corresponding to the incident position in the sagittal direction or the tangential direction of the light beam. In B of FIG. 5, a solid-line represents the relationship between the incident position in the tangential direction and the field curvature, and a dotted-line represents the relationship between the incident position in the sagittal direction and the field curvature. It similarly applies to B of FIG. 9, B of FIG. 13, B of FIG. 17, and B of FIG. 21 to be described later. The difference in field curvature between the sagittal direction and the tangential direction is astigmatism.

C of FIG. 5 is a graph illustrating distortion aberration of light having a wavelength of 0.546 mm, which occurs in the lens optical system 25 of FIG. 2. In the graph in C of FIG. 5, the horizontal axis represents distortion aberration [%], and the vertical axis represents the incident angle [degree] of the light beam. It similarly applies to C of FIG. 9, C of FIG. 13, C of FIG. 17, and C of FIG. 21 to be described later.

As illustrated in A to C of FIG. 5, good aberration correction is performed in the lens optical system 25 of FIG. 2, and good imaging quality is realized in the lens optical system 25 of FIG. 2.

### <Second Configuration Example of Lens Optical System>

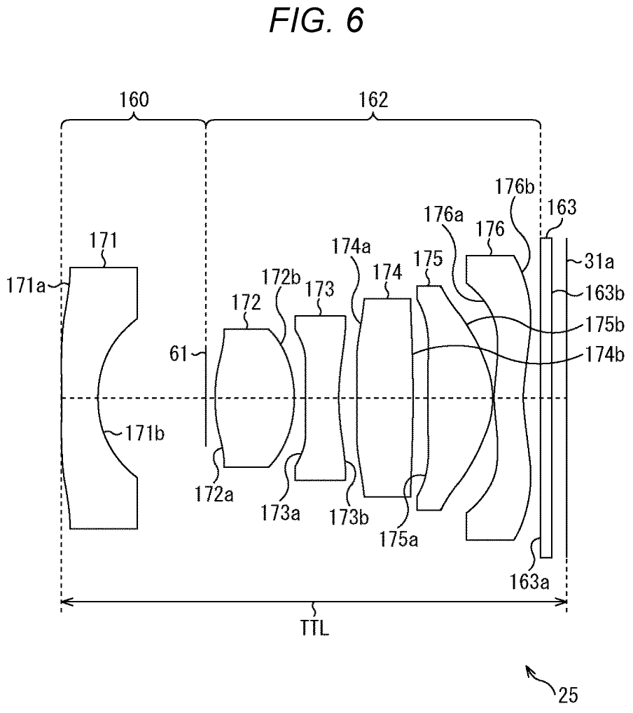

FIG. 6 is a cross-sectional view illustrating a second configuration example of the lens optical system 25.

In the lens optical system 25 of FIG. 6, portions corresponding to those of the lens optical system 25 of FIG. 2 are denoted by the same reference signs. Therefore, description of the portion is appropriately omitted, and description will be given focusing on a portion different from the lens optical system 25 in FIG. 2. The lens optical system 25 of FIG. 6 is different from the lens optical system 25 of FIG. 2 in that the lens group 60, the lens group 62, and the IR cut filter 63 are replaced with the lens group 160, the lens group 162, and the IR cut filter 163, and is configured in a manner similar to the lens optical system 25 of FIG. 2 except for this.

The lens group 160 includes the lens 171. The lens group 162 includes lenses 172 to 176. The lenses 171 to 176 are different from the lenses 71 to 76 in that setting data, aspherical data of each surface, and the lens 174 has negative refractive power, and are configured similarly to the lenses 71 to 76 except for this. The IR cut filter 163 has setting data different from that of the IR cut filter 63, and the rest is configured similarly to the IR cut filter 63.

Therefore, setting data of the lenses 171 to 176 and the IR cut filter 163 and aspherical data of the object-side surfaces 171a to 176a and the image-side surfaces 171b to 176b of the lenses 171 to 176 will be described below.

Note that the total length TTL of the lens optical system 25 in FIG. 6 is a distance on the optical axis between the surface 171a and the imaging surface 31a.

### <Second Example of Setting Data of Each Lens and IR Cut Filter>

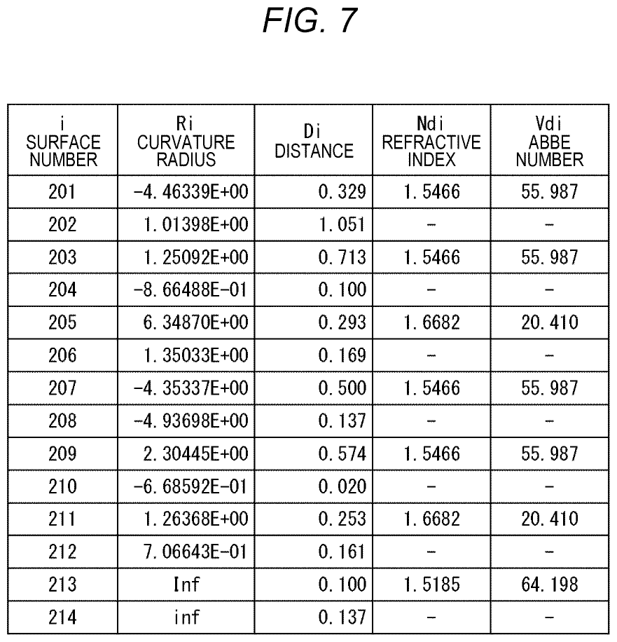

FIG. 7 is a table illustrating setting data of the lenses 171 to 176 and the IR cut filter 163.

Each row in the table of FIG. 7 corresponds to each of the surfaces 163a and 163b, the surfaces 171a to 176a, and the surfaces 171b to 176b. Each column corresponds to the surface number i, the curvature radius Ri, the surface distance Di, the refractive index Ndi with respect to the d-line, and the Abbe number Vdi at the d-line in order from the left side.

In the present specification, it is assumed that surface numbers from 201 to 214 are sequentially assigned to surfaces 171a, 171b, 172a, 172b, 173a, 173b, 174a, 174b, 175a, 175b, 176a, 176b, 163a, and 163b. See FIG. 7 for numerical values in each column of the table of FIG. 7.

### <Second Example of Aspherical Data of Each Surface>

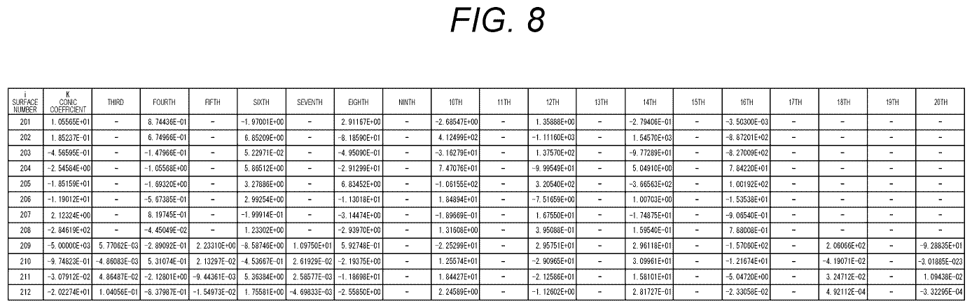

FIG. 8 is a table illustrating aspherical data of the surfaces 171a to 176a and the surfaces 171b to 176b.

Each row in the table of FIG. 8 corresponds to each of the surfaces 171a to 176a and the surfaces 171b to 176b. Each column corresponds to a surface number i, a conic coefficient K, and a third order aspheric coefficient to a 20th order aspheric coefficient in order from the left side. See FIG. 8 for numerical values in each column of the table of FIG. 8.

### <Second Example of Spherical Aberration, Field Curvature, and Distortion Aberration>

FIG. 9 is a graph illustrating spherical aberration, field curvature, and distortion aberration generated in the lens optical system 25 in FIG. 6.

A of FIG. 9 is a graph illustrating spherical aberration in the longitudinal direction for each wavelength of light having wavelengths of 0.486 mm, 0.588 mm, and 0.656 mm, which occurs in the lens optical system 25 of FIG. 6. In A of FIG. 9, the pupil radius is 0.2444 mm. B of FIG. 9 is a graph illustrating field curvature of light having a wavelength of 0.546 mm generated in the lens optical system 25 of FIG. 6. C of FIG. 9 is a graph illustrating distortion aberration of light having a wavelength of 0.546 mm, which occurs in the lens optical system 25 of FIG. 6.

As illustrated in A to C of FIG. 9, good aberration correction is performed in the lens optical system 25 of FIG. 6, and good imaging quality is realized in the lens optical system 25 of FIG. 6.

### <Third Configuration Example of Lens Optical System>

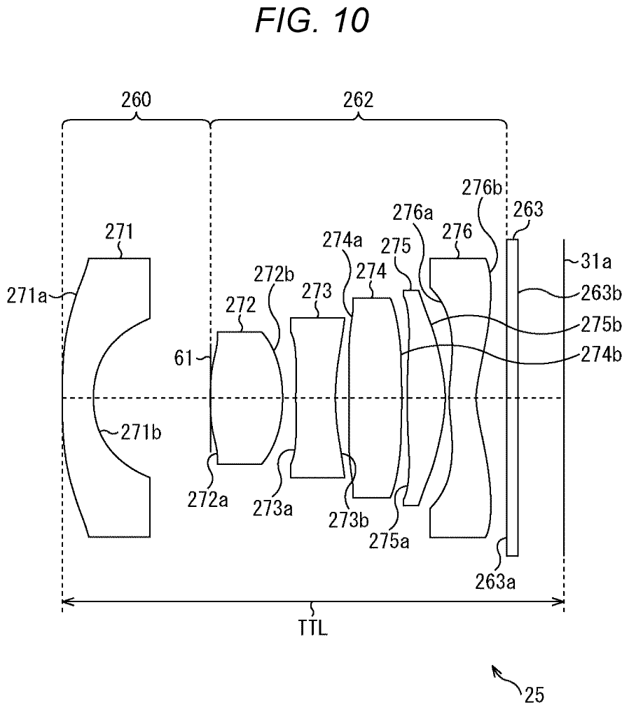

FIG. 10 is a cross-sectional view illustrating a third configuration example of the lens optical system 25.

In the lens optical system 25 of FIG. 10, portions corresponding to those of the lens optical system 25 of FIG. 2 are denoted by the same reference signs. Therefore, description of the portion is appropriately omitted, and description will be given focusing on a portion different from the lens optical system 25 in FIG. 2. The lens optical system 25 of FIG. 10 is different from the lens optical system 25 of FIG. 2 in that the lens group 60, the lens group 62, and the IR cut filter 63 are replaced with the lens group 260, the lens group 262, and the IR cut filter 263, and is configured in a manner similar to the lens optical system 25 of FIG. 2 except for this.

The lens group 260 includes the lens 271. The lens group 262 includes lenses 272 to 276. The lenses 271 to 276 are different from the lenses 71 to 76 in the setting data and the aspherical data of each surface, and are configured similarly to the lenses 71 to 76 in the other respects. The IR cut filter 263 has setting data different from that of the IR cut filter 63, and the rest is configured similarly to the IR cut filter 63.

Therefore, setting data of the lenses 271 to 276 and the IR cut filter 263 and aspherical data of the object-side surfaces 271a to 276a and the image-side surfaces 271b to 276b of the lenses 271 to 276 will be described below.

Note that the total length TTL of the lens optical system 25 in FIG. 10 is a distance on the optical axis between the surface 271a and the imaging surface 31a.

### <Third Example of Setting Data of Each Lens and IR Cut Filter>

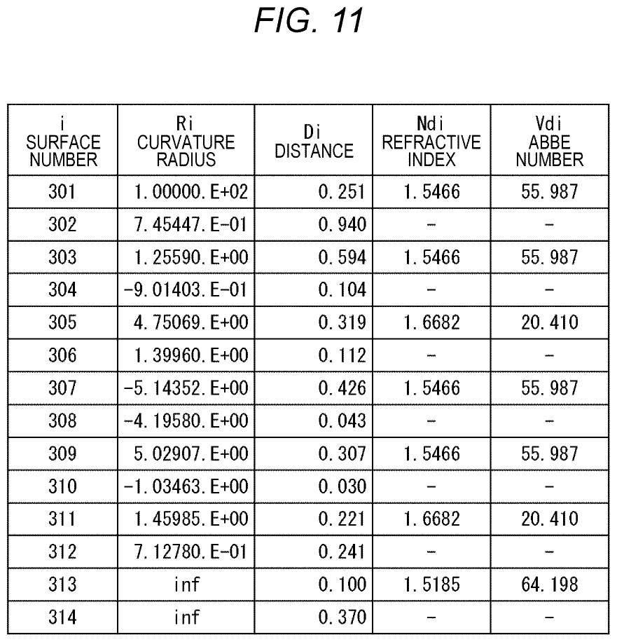

FIG. 11 is a table illustrating setting data of the lenses 271 to 276 and the IR cut filter 263.

Each row in the table of FIG. 11 corresponds to each of surfaces 263a and 263b, surfaces 271a to 276a, and surfaces 271b to 276b. Each column corresponds to the surface number i, the curvature radius Ri, the surface distance Di, the refractive index Ndi with respect to the d-line, and the Abbe number Vdi at the d-line in order from the left side.

In the present specification, it is assumed that surface numbers from 301 to 314 are sequentially assigned to surfaces 271a, 271b, 272a, 272b, 273a, 273b, 274a, 274b, 275a, 275b, 276a, 276b, 263a, and 263b. See FIG. 11 for numerical values in each column of the table of FIG. 11.

### <Third Example of Aspherical Data of Each Surface>

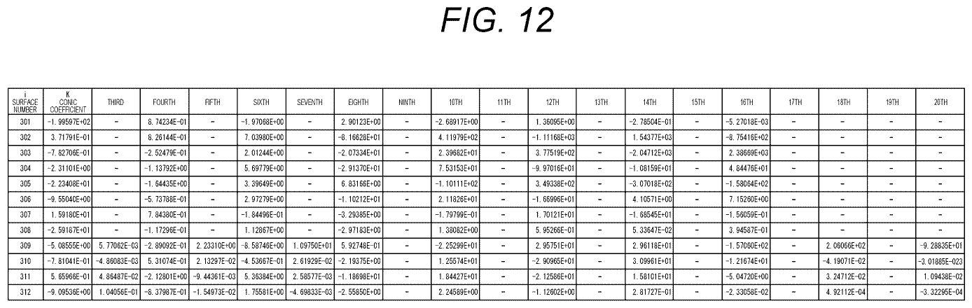

FIG. 12 is a table illustrating aspherical data of the surfaces 271a to 276a and the surfaces 271b to 276b.

Each row in the table of FIG. 12 corresponds to each of the surfaces 271a to 276a and the surfaces 271b to 276b. Each column corresponds to a surface number i, a conic coefficient K, and a third order aspheric coefficient to a 20th order aspheric coefficient in order from the left side. See FIG. 12 for numerical values in each column of the table of FIG. 12.

### <Third Example of Spherical Aberration, Field Curvature, and Distortion Aberration>

FIG. 13 is a graph illustrating spherical aberration, field curvature, and distortion aberration generated in the lens optical system 25 in FIG. 10.

A of FIG. 13 is a graph illustrating spherical aberration in the longitudinal direction for each wavelength of light having wavelengths of 0.486 mm, 0.588 mm, and 0.656 mm, which occurs in the lens optical system 25 of FIG. 10. In A of FIG. 13, the pupil radius is 0.2430 mm. B of FIG. 13 is a graph illustrating field curvature of light having a wavelength of 0.546 mm generated in the lens optical system 25 of FIG. 10. C of FIG. 13 is a graph illustrating distortion aberration of light having a wavelength of 0.546 mm, which occurs in the lens optical system 25 of FIG. 10.

As illustrated in A to C of FIG. 13, good aberration correction is performed in the lens optical system 25 of FIG. 10, and good imaging quality is realized in the lens optical system 25 of FIG. 10.

### <Fourth Configuration Example of Lens Optical System>

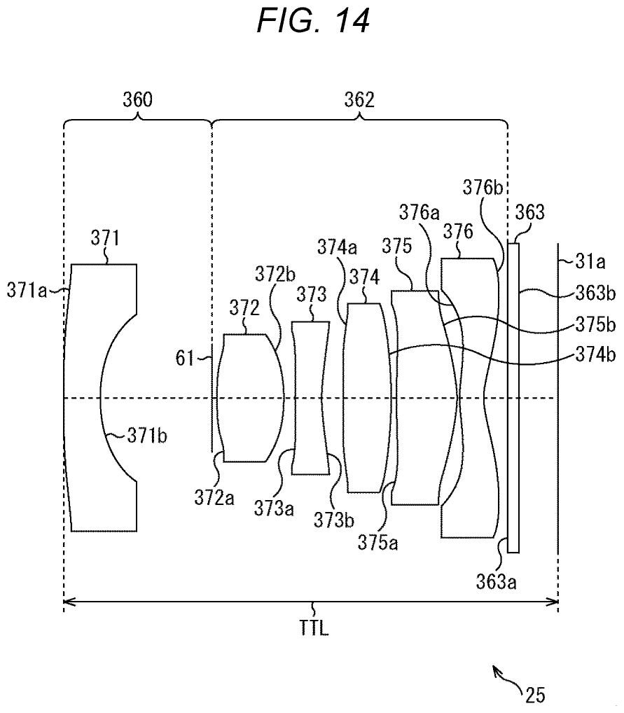

FIG. 14 is a cross-sectional view illustrating a fourth configuration example of the lens optical system 25.

In the lens optical system 25 of FIG. 14, portions corresponding to those of the lens optical system 25 of FIG. 2 are denoted by the same reference signs. Therefore, description of the portion is appropriately omitted, and description will be given focusing on a portion different from the lens optical system 25 in FIG. 2. The lens optical system 25 of FIG. 14 is different from the lens optical system 25 of FIG. 2 in that the lens group 60, the lens group 62, and the IR cut filter 63 are replaced with the lens group 360, the lens group 362, and the IR cut filter 363, and is configured in a manner similar to the lens optical system 25 of FIG. 2 except for this.

The lens group 360 includes the lens 371. The lens group 362 includes lenses 372 to 376. The lenses 371 to 376 are different from the lenses 71 to 76 in the setting data and the aspherical data of each surface, and are configured similarly to the lenses 71 to 76 in the other respects. The IR cut filter 363 has setting data different from that of the IR cut filter 63, and the rest is configured similarly to the IR cut filter 63.

Therefore, setting data of the lenses 371 to 376 and the IR cut filter 363 and aspherical data of the object-side surfaces 371a to 376a and the image-side surfaces 371b to 376b will be described below.

Note that the total length TTL of the lens optical system 25 in FIG. 14 is a distance on the optical axis between the surface 371a and the imaging surface 31a.

### <Fourth Example of Setting Data of Each Lens and IR Cut Filter>

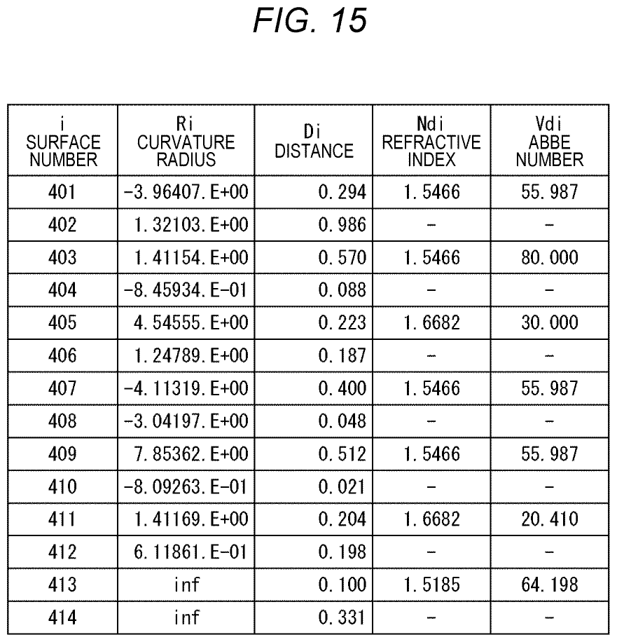

FIG. 15 is a table illustrating setting data of the lenses 371 to 376 and the IR cut filter 363.

Each row in the table of FIG. 15 corresponds to each of surfaces 363a and 363b, surfaces 371a to 376a, and surfaces 371b to 376b. Each column corresponds to the surface number i, the curvature radius Ri, the surface distance Di, the refractive index Ndi with respect to the d-line, and the Abbe number Vdi at the d-line in order from the left side.

In the present specification, it is assumed that surface numbers from 401 to 414 are sequentially assigned to surfaces 371a, 371b, 372a, 372b, 373a, 373b, 374a, 374b, 375a, 375b, 376a, 376b, 363a, and 363b. See FIG. 15 for numerical values in each column of the table of FIG. 15.

### <Fourth Example of Aspherical Data of Each Surface>

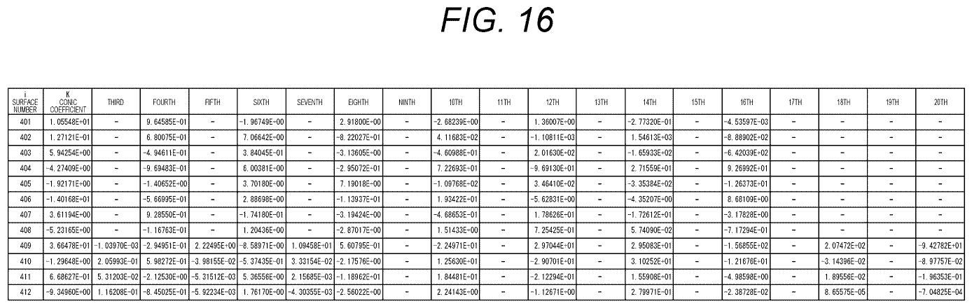

FIG. 16 is a table illustrating aspherical data of the surfaces 371a to 376a and the surfaces 371b to 376b.

Each row in the table of FIG. 16 corresponds to each of the surfaces 371a to 376a and the surfaces 371b to 376b. Each column corresponds to a surface number i, a conic coefficient K, and a third order aspheric coefficient to a 20th order aspheric coefficient in order from the left side. See FIG. 16 for numerical values in each column of the table of FIG. 16.

### <Fourth Example of Spherical Aberration, Field Curvature, and Distortion Aberration>

FIG. 17 is a graph illustrating spherical aberration, field curvature, and distortion aberration generated in the lens optical system 25 in FIG. 14.

A of FIG. 17 is a graph illustrating spherical aberration in the longitudinal direction for each wavelength of light having wavelengths of 0.486 mm, 0.588 mm, and 0.656 mm, which occurs in the lens optical system 25 of FIG. 14. In A of FIG. 17, the pupil radius is 0.2632 mm. B of FIG. 17 is a graph illustrating field curvature of light having a wavelength of 0.546 mm generated in the lens optical system 25 of FIG. 14. C of FIG. 17 is a graph illustrating distortion aberration of light having a wavelength of 0.546 mm, which occurs in the lens optical system 25 of FIG. 14.

As illustrated in A to C of FIG. 17, good aberration correction is performed in the lens optical system 25 of FIG. 14, and good imaging quality is realized in the lens optical system 25 of FIG. 14.

### <Fifth Configuration Example of Lens Optical System>

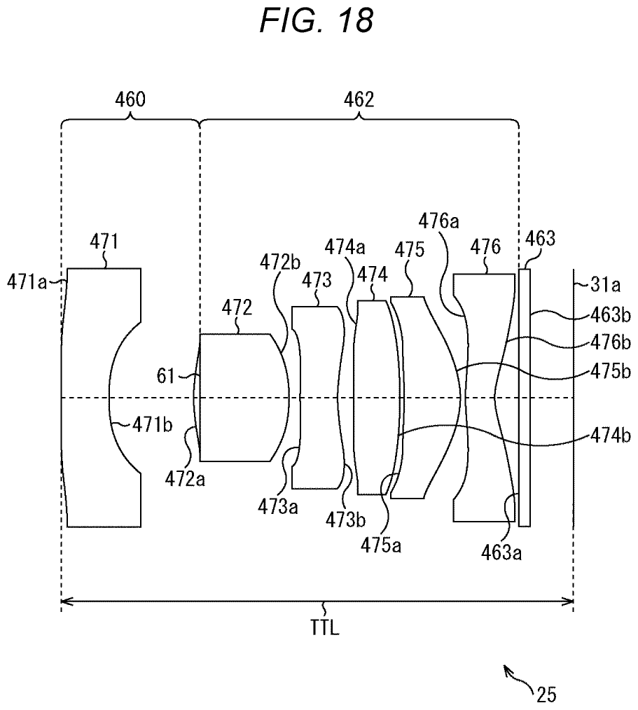

FIG. 18 is a cross-sectional view illustrating a fifth configuration example of the lens optical system 25.

In the lens optical system 25 of FIG. 18, portions corresponding to those of the lens optical system 25 of FIG. 2 are denoted by the same reference signs. Therefore, description of the portion is appropriately omitted, and description will be given focusing on a portion different from the lens optical system 25 in FIG. 2. The lens optical system 25 of FIG. 18 is different from the lens optical system 25 of FIG. 2 in that the lens group 60, the lens group 62, and the IR cut filter 63 are replaced with the lens group 460, the lens group 462, and the IR cut filter 463, and is configured in a manner similar to the lens optical system 25 of FIG. 2 except for this.

The lens group 460 includes the lens 471. The lens group 462 includes lenses 472 to 476. The lenses 471 to 476 are different from the lenses 71 to 76 in the setting data and the aspherical data of each surface, and are configured similarly to the lenses 71 to 76 in the other respects. The IR cut filter 463 has setting data different from that of the IR cut filter 63, and the rest is configured similarly to the IR cut filter 63.

Therefore, setting data of the lenses 471 to 476 and the IR cut filter 463 and aspherical data of the object-side surfaces 471a to 476a and the image-side surfaces 471b to 476b will be described below.

Note that the total length TTL of the lens optical system 25 in FIG. 18 is a distance on the optical axis between the surface 471a and the imaging surface 31a.

### <Fifth Example of Setting Data of Each Lens and IR Cut Filter>

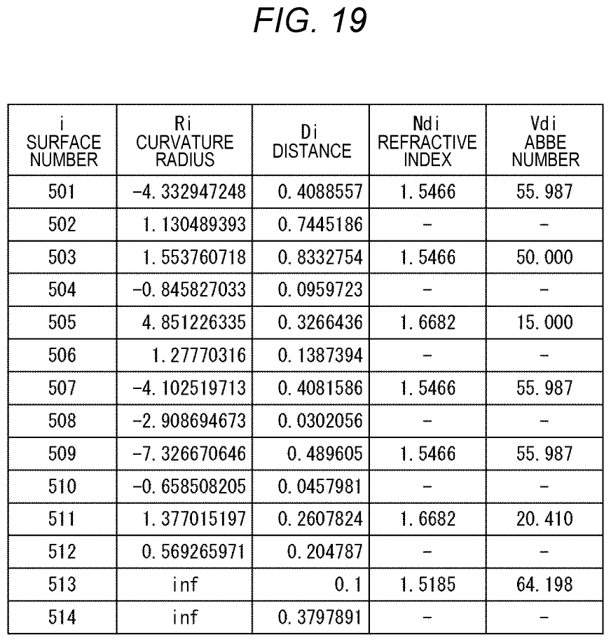

FIG. 19 is a table illustrating setting data of the lenses 471 to 476 and the IR cut filter 463.

Each row in the table of FIG. 19 corresponds to each of surfaces 463a and 463b, surfaces 471a to 476a, and surfaces 471b to 476b. Each column corresponds to the surface number i, the curvature radius Ri, the surface distance Di, the refractive index Ndi with respect to the d-line, and the Abbe number Vdi at the d-line in order from the left side.

In the present specification, it is assumed that surface numbers from 501 to 514 are sequentially assigned to surfaces 471a, 471b, 472a, 472b, 473a, 473b, 474a, 474b, 475a, 475b, 476a, 476b, 463a, and 463b. See FIG. 19 for numerical values in each column of the table of FIG. 19.

### <Fifth Example of Aspherical Data of Each Surface>

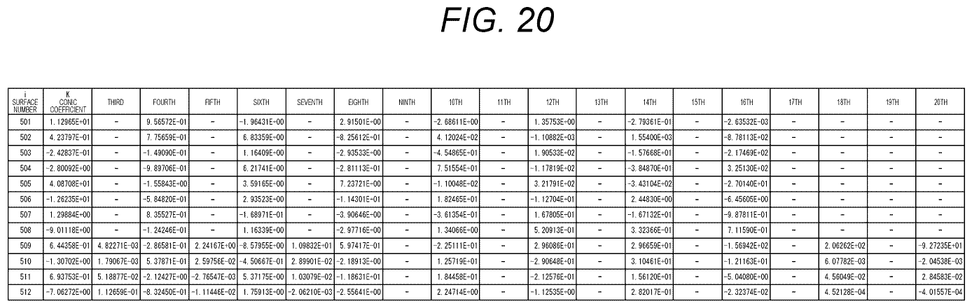

FIG. 20 is a table illustrating aspherical data of the surfaces 471a to 476a and the surfaces 471b to 476b.

Each row in the table of FIG. 20 corresponds to each of the surfaces 471a to 476a and the surfaces 471b to 476b. Each column corresponds to a surface number i, a conic coefficient K, and a third order aspheric coefficient to a 20th order aspheric coefficient in order from the left side. See FIG. 20 for numerical values in each column of the table of FIG. 20.

### <Fifth Example of Spherical Aberration, Field Curvature, and Distortion Aberration>

FIG. 21 is a graph illustrating spherical aberration, field curvature, and distortion aberration generated in the lens optical system 25 in FIG. 18.

A of FIG. 21 is a graph illustrating spherical aberration in the longitudinal direction for each wavelength of light having wavelengths of 0.486 mm, 0.588 mm, and 0.656 mm, which occurs in the lens optical system 25 of FIG. 18. In A of FIG. 21, the pupil radius is 0.2682 mm. B of FIG. 21 is a graph illustrating field curvature of light having a wavelength of 0.546 mm generated in the lens optical system 25 of FIG. 18. C of FIG. 21 is a graph illustrating distortion aberration of light having a wavelength of 0.546 mm, which occurs in the lens optical system 25 of FIG. 18.

As illustrated in A to C of FIG. 21, good aberration correction is performed in the lens optical system 25 of FIG. 18, and good imaging quality is realized in the lens optical system 25 of FIG. 18.

### <Value of Parameter or Formula>

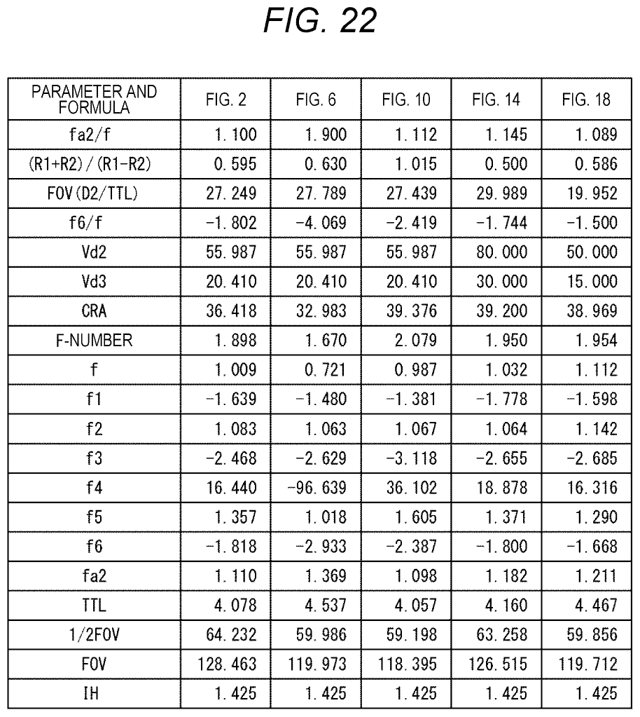

FIG. 22 is a table illustrating values of parameters or expressions in the lens optical system 25 in FIGS. 2, 6, 10, 14, and 18.

Each row in the table of FIG. 22 corresponds to fa2/f, (R1+R2)/(R1−R2), FOV (D2/TTL), f6/f, Vd2, Vd3, CRA, F-number, f, f1 to f6, fa2, TTL, ½FOV, FOV, and IH in order from the top. Each column corresponds to the lens optical system 25 in FIGS. 2, 6, 10, 14, and 18 in order from the left side.

Here, fa2 is a generic term for focal lengths of the lens groups 62, 162, 262, 362 and 462, and f is a focal length of the entire lens optical system 25. R1 and R2 are generic terms of curvature radii Rj01 and Rj02 (j=1, 2, 3, 4, and 5), respectively. The FOV is a viewing angle of the lens optical system 25, and D2 is a generic term for the interval Dj01. fp (p=1, 2, 3, 4, 5, and 6) is a generic term for focal lengths of the lenses 7p, 17p, 27p, 37p, and 47p.

Vd2 and Vd3 are generic terms for the Abbe number Vj02 and the Abbe number Vj03, respectively. Note that the Abbe number V202 (302, 402, 502) is the Abbe number of the lens 172 (272, 372, 472), and is the Abbe number Vd203 (303, 403, 503) of the surface 172a (272a, 372a, 472a). The Abbe number V203 (303, 403, 503) is the Abbe number of the lens 173 (273, 373, 473), and is the Abbe number Vd205 (305, 405, 505) of the surface 173a (273a, 373a, 473a).

CRA is a principal ray angle of light incident on the imaging surface 31a from the lens optical system 25. IH is the maximum height increase that is the distance from the center of the imaging surface 31a to the position where the principal ray of the light beam with the maximum angle of view reaches.

As illustrated in FIG. 22, in the lens optical system 25 in FIGS. 2, 6, 10, 14, and 18, fa2/f is 1.100, 1.900, 1.112, 1.145, and 1.089, respectively. Therefore, the lens optical system 25 in FIGS. 2, 6, 10, 14, and 18 satisfies the following conditional expression (1).

$$1 \leq fa 2 / f \leq 2 \qquad ( 1 )$$

The lens optical system 25 can control the marginal light beam in the vicinity of the optical axis and reduce the F-number by satisfying the conditional expression (1).

On the other hand, in a case where fa2/f is less than the lower limit of the conditional expression (1), since the focal length fa2 is short, the sensitivity in the lens group 62 (162, 262, 362, 462) increases, and it is difficult to ensure good imaging quality.

Meanwhile, in a case where fa2/f exceeds the upper limit of the conditional expression (1), aberration correction in the marginal light beam becomes difficult because of the long focal length fa2. In addition, when the focal length fa2 is long, the interval between the lens group 60 (160, 260, 360, 460) and the lens group 62 (162, 262, 362, 462) is also long, and the total length TTL of the lens optical system 25 is long. If the increase in the total length TTL of the lens optical system 25 is suppressed in a case where the focal length fa2 is long, it becomes difficult for the lens group 60 (160, 260, 360, 460) to correct the spherical aberration generated in the lens group 62 (162, 262, 362, 462).

In the lens optical system 25 in FIGS. 2, 6, 10, 14, and 18, (R1+R2)/(R1−R2) is 0.595, 0.630, 1.015, 0.500, and 0.586, respectively. Therefore, the lens optical system 25 in FIGS. 2, 6, 10, 14, and 18 satisfies the following conditional expression (2).

$$0.5 \leq ( R 1 + R 2 ) / ( R 1 - R 2 ) \leq 1.1 \qquad ( 2 )$$

The lens optical system 25 can set the angle of the light beam emitted from the lens 71 (171, 271, 371, 471) to an appropriate angle by satisfying the conditional expression (2). Therefore, the angle can be widened more easily.

On the other hand, in a case where (R1+R2)/(R1−R2) exceeds the upper limit of the conditional expression (2), the ratio TTL/IH of the total length TTL to the maximum image height IH is 3.0 or more, which is larger than the ratio in a general lens optical system, which is not preferable.

In the lens optical system 25 in FIGS. 2, 6, 10, 14, and 18, FOVs (D2/TTL) are 27.249, 27.789, 27.439, 29.989, and 19.952, respectively. Therefore, the lens optical system 25 in FIGS. 2, 6, 10, 14, and 18 satisfies the following conditional expression (3).

$$15 \leq FOV ( D 2 / TTL ) \leq 30 \qquad ( 3 )$$

By satisfying the conditional expression (3), the lens optical system 25 can efficiently correct various aberrations and reduce the height. As a result, the lens optical system 25 having a low height and a small F-number can be realized.

On the other hand, in a case where the FOV (D2/TTL) falls below the lower limit of the conditional expression (3), it is difficult for the light beam from the lens 71 (171, 271, 371, 471) to enter the aperture diaphragm 61 (161, 261, 361, 461) at an appropriate angle. Therefore, it is necessary to narrow the angle of view, and it is difficult to widen the angle of view of the lens optical system 25. Meanwhile, in a case where FOV (D2/TTL) exceeds the conditional expression (3), the total length TTL becomes long, so that it is difficult to miniaturize the lens optical system 25.

In the lens optical system 25 in FIGS. 2, 6, 10, 14, and 18, f6/f is −1.802, −4.069, −2.419, −1.744, and −1.500, respectively. Therefore, the lens optical system 25 in FIGS. 2, 6, 10, 14, and 18 satisfies the following conditional expression (4).

$$- 4.5 \leq f 6 / f \leq - 1.5 \qquad ( 4 )$$

The lens optical system 25 can satisfactorily correct distortion aberration and coma aberration while securing back focus by satisfying the conditional expression (4).

In the lens optical system 25 in FIGS. 2, 6, and 10, Abbe numbers Vd2 are all 55.987. In the lens optical system 25 of FIGS. 14 and 18, the Abbe numbers Vd2 are 80.000 and 50.000, respectively. Therefore, the lens optical system 25 in FIGS. 2, 6, 10, 14, and 18 satisfies the following conditional expression (5).

$$50 \leq Vd 2 \leq 80 \qquad ( 5 )$$

The lens optical system 25 can effectively realize the aberration correction by satisfying the conditional expression (5). On the other hand, in a case where Vd2 exceeds the upper limit of the conditional expression (5), it is difficult to correct the spherical aberration. Meanwhile, in a case where Vd2 is less than the lower limit of the conditional expression (5), it is difficult to correct the axial chromatic aberration.

In the lens optical system 25 in FIGS. 2, 6, and 10, the Abbe numbers Vd3 are all 20.410. In the lens optical system 25 in FIGS. 14 and 18, Vd3 is 30.000 and 15.000, respectively. Therefore, the lens optical system 25 in FIGS. 2, 6, 10, 14, and 18 satisfies the following conditional expression (6).

$$15 \leq Vd 3 \leq 30 \qquad ( 6 )$$

The lens optical system 25 can effectively realize the aberration correction by satisfying the conditional expression (6). On the other hand, in a case where Vd3 exceeds the upper limit of the conditional expression (6), it is difficult to correct the spherical aberration. Meanwhile, in a case where Vd3 is less than the lower limit of the conditional expression (6), it is difficult to correct the axial chromatic aberration.

In the lens optical system 25 in FIGS. 2, 6, 10, 14, and 18, the principal ray angles CRA are 36.418, 32.983, 39.376, 39.200, and 38.969, respectively. Therefore, the lens optical system 25 in FIGS. 2, 6, 10, 14, and 18 satisfies the following conditional expression (7).

$$CRA < 40 \qquad ( 7 )$$

The lens optical system 25 can suppress a decrease in the amount of light in the peripheral portion by satisfying the conditional expression (7).

F-numbers of the lens optical system 25 in FIGS. 2, 6, 10, 14, and 18 are 1.898, 1.670. 2.079, 1.950, and 1.954, respectively. Therefore, in the lens optical system 25 of FIGS. 2, 6, 10, 14, and 18, a small F-number is realized.

The focal lengths f of the entire lens optical system 25 in FIGS. 2, 6, 10, 14, and 18 are 1.0009, 0.721, 0.987, 1.032, and 1.112, respectively.

The focal lengths f1 to f6 of the lenses 71 to 76 are −1.639, 1.083, −2.468, 16.440, 1.357, and −1.818, respectively. The focal lengths f1 to f6 of the lenses 171 to 176 are −1.480, 1.063, −2.629, −96.639, 1.018, and −2.933, respectively. The focal lengths f1 to f6 of the lenses 271 to 276 are −1.381, 1.067, −3.118, 36.102, 1.605, and −2.387, respectively. The focal lengths f1 to f6 of the lenses 371 to 376 are −1.778, 1.064, −2.655, 18.878, 1.371, and −1.800, respectively. The focal lengths f1 to f6 of the lenses 471 to 476 are −1.598, 1.142, −2.685, 16.316, 1.290, and −1.668, respectively.

The focal lengths of the lens groups 62, 162, 262, 362, and 462 are 1.110, 1.369, 1.098, 1.182, and 1.211, respectively.

The total length TTL of the lens optical system 25 in FIGS. 2, 6, 10, 14, and 18 is 4.078, 4.537, 4.057, 4.160, and 4.467, respectively. Therefore, miniaturization is realized in the lens optical system 25.

In the lens optical system 25 in FIGS. 2, 6, 10, 14, and 18, ½FOV that is ½ times the viewing angle FOV is 64.232, 59.986, 59.198, 63.258, and 59.856, respectively. Therefore, the viewing angles FOV are 128.463, 119.973, 118.395, 126.515, and 119.712, respectively. Therefore, the lens optical system 25 achieves a wide angle.

In the lens optical system 25 of FIGS. 2, 6, 10, 14, and 18, the maximum image height IH is 1.425.

As described above, the lens optical system 25 includes the lens group 60 (160, 260, 360, 460) having negative refractive power and the lens group 62 (162, 262, 362, 462) having positive refractive power in order from the object side toward the image side. The lens group 60 (160, 260, 360, 460) includes the lens 71 (171, 271, 371, 471) having negative refractive power. The lens group 62 (162, 262, 362, 462) includes lenses 72 (172, 272, 372, 472) to 76 (176, 276, 376, 476) in order from the object side toward the image side. The lens 72 (172, 272, 372, 472) has positive refractive power, the lens 73 (173, 273, 373, 473) has negative refractive power, and the lens 74 (174, 274, 374, 474) has positive or negative refractive power. The lens 75 (175, 275, 375, 475) has a positive refractive power, and the lens 76 (176, 276, 376, 476) has a negative refractive power. Then, the lens optical system 25 satisfies the above-described conditional expression (1). Therefore, the lens optical system 25 can realize both good aberration correction and a small F-number at a low height and a wide angle. As a result, the lens optical system 25 can realize both good imaging quality (high resolving power) and a small F-number with a small size and a wide angle.

Note that the numerical values of the setting data and the aspherical data in the lens optical system 25 are not limited to the above-described numerical values.

### 2. Application Example to Electronic Device

The imaging apparatus 10 described above can be applied to, for example, a digital still camera, a digital video camera, a mobile terminal apparatus such as a mobile phone or a smartphone having an imaging function, and various electronic devices such as a monitor or a personal computer.

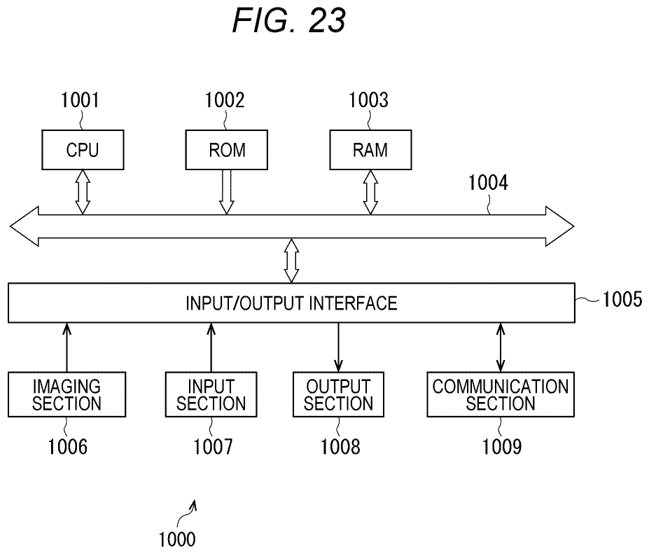

FIG. 23 is a block diagram illustrating a hardware configuration example of a smartphone as an electronic device to which the present technology is provided.

In the smartphone 1000, a central processing unit (CPU) 1001, a read only memory (ROM) 1002, and a random access memory (RAM) 1003 are mutually connected by a bus 1004.

An input/output interface 1005 is further connected to the bus 1004. An imaging section 1006, an input section 1007, an output section 1008, and a communication section 1009 are connected to the input/output interface 1005.

The imaging section 1006 includes the above-described imaging apparatus 10 and the like. The imaging section 1006 images a subject and acquires an image. This image is stored in the RAM 1003 or displayed on the output section 1008. The input section 1007 includes a touch pad which is a position input apparatus constituting a touch panel, a microphone, and the like. The output section 1008 includes a liquid crystal panel constituting a touch panel, a speaker, and the like. The communication section 1009 includes a network interface and the like.

Also in the smartphone 1000 configured as described above, by applying the imaging apparatus 10 as the imaging section 1006, both good imaging quality and a small F-number can be realized in a small size and wide angle. As a result, smartphone 1000 can capture a bright image with high image quality.

### 3. Usage Example of Imaging Apparatus

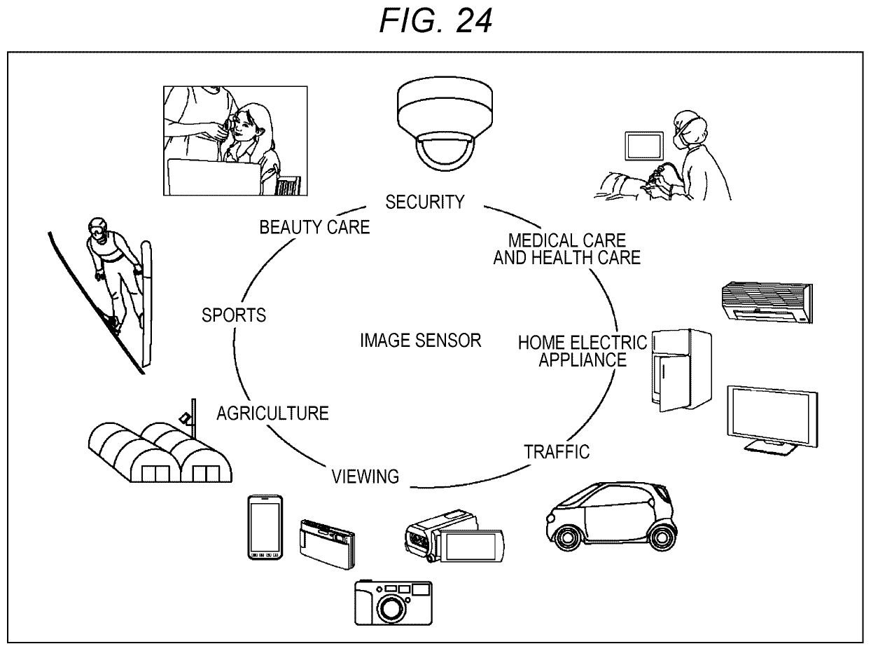

FIG. 24 is a diagram illustrating a usage example of using the above-described imaging apparatus 10.

The above-described imaging apparatus 10 can be used, for example, in various cases of sensing light such as visible light, infrared light, ultraviolet light, and X-rays as described below.
An apparatus that captures an image to be used for viewing, such as a digital camera or a portable device with a camera function
An apparatus used for traffic, such as an in-vehicle sensor that captures images of the front, rear, surroundings, inside, and the like of an automobile for safe driving such as automatic stop, recognition of a driver's condition, and the like, a monitoring camera that monitors traveling vehicles and roads, and a distance measuring sensor that measures a distance between vehicles and the like
An apparatus used for home electric appliances such as a TV, a refrigerator, and an air conditioner in order to capture an image of a gesture of a user and perform a device operation according to the gesture
An apparatus used for medical care or health care, such as an endoscope or an apparatus that performs angiography by receiving infrared light
An apparatus used for security, such as a monitoring camera for crime prevention or a camera for person authentication
An apparatus used for beauty care, such as a skin condition measuring instrument for capturing skin or a microscope for capturing scalp
An apparatus used for sports, such as an action camera or a wearable camera for sports or the like
An apparatus used for agriculture, such as a camera for monitoring conditions of fields and crops

### 4. Application Example to Endoscopic Surgery System

The technology according to the present disclosure (present technology) can be applied to various products. For example, the technology according to the present disclosure may be applied to an endoscopic surgery system.

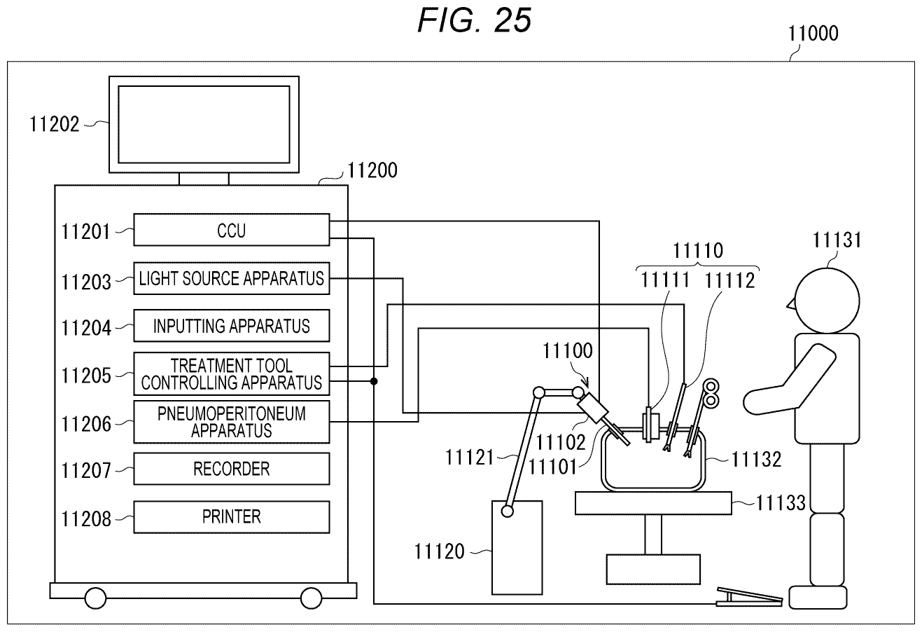

FIG. 25 is a view depicting an example of a schematic configuration of an endoscopic surgery system to which the technology according to an embodiment of the present disclosure (present technology) can be applied.

In FIG. 25, a state is illustrated in which a surgeon (medical doctor) 11131 is using an endoscopic surgery system 11000 to perform surgery for a patient 11132 on a patient bed 11133. As depicted, the endoscopic surgery system 11000 includes an endoscope 11100, other surgical tools 11110 such as a pneumoperitoneum tube 11111 and an energy device 11112, a supporting arm apparatus 11120 which supports the endoscope 11100 thereon, and a cart 11200 on which various apparatus for endoscopic surgery are mounted.

The endoscope 11100 includes a lens barrel 11101 having a region of a predetermined length from a distal end thereof to be inserted into a body cavity of the patient 11132, and a camera head 11102 connected to a proximal end of the lens barrel 11101. In the example depicted, the endoscope 11100 is depicted which includes as a rigid endoscope having the lens barrel 11101 of the hard type. However, the endoscope 11100 may otherwise be included as a flexible endoscope having the lens barrel 11101 of the flexible type.

The lens barrel 11101 has, at a distal end thereof, an opening in which an objective lens is fitted. A light source apparatus 11203 is connected to the endoscope 11100 such that light generated by the light source apparatus 11203 is introduced to a distal end of the lens barrel 11101 by a light guide extending in the inside of the lens barrel 11101 and is irradiated toward an observation target in a body cavity of the patient 11132 through the objective lens. It is to be noted that the endoscope 11100 may be a forward-viewing endoscope or may be an oblique-viewing endoscope or a side-viewing endoscope.

An optical system and an image pickup element are provided in the inside of the camera head 11102 such that reflected light (observation light) from the observation target is condensed on the image pickup element by the optical system. The observation light is photo-electrically converted by the image pickup element to generate an electric signal corresponding to the observation light, namely, an image signal corresponding to an observation image. The image signal is transmitted as RAW data to a CCU 11201.

The CCU 11201 includes a central processing unit (CPU), a graphics processing unit (GPU) or the like and integrally controls operation of the endoscope 11100 and a display apparatus 11202. Further, the CCU 11201 receives an image signal from the camera head 11102 and performs, for the image signal, various image processes for displaying an image based on the image signal such as, for example, a development process (demosaic process).

The display apparatus 11202 displays thereon an image based on an image signal, for which the image processes have been performed by the CCU 11201, under the control of the CCU 11201.

The light source apparatus 11203 includes a light source such as, for example, a light emitting diode (LED) and supplies irradiation light upon imaging of a surgical region to the endoscope 11100.

An inputting apparatus 11204 is an input interface for the endoscopic surgery system 11000. A user can perform inputting of various kinds of information or instruction inputting to the endoscopic surgery system 11000 through the inputting apparatus 11204. For example, the user would input an instruction or a like to change an image pickup condition (type of irradiation light, magnification, focal distance or the like) by the endoscope 11100.

A treatment tool controlling apparatus 11205 controls driving of the energy device 11112 for cautery or incision of a tissue, sealing of a blood vessel or the like. A pneumoperitoneum apparatus 11206 feeds gas into a body cavity of the patient 11132 through the pneumoperitoneum tube 11111 to inflate the body cavity in order to secure the field of view of the endoscope 11100 and secure the working space for the surgeon. A recorder 11207 is an apparatus capable of recording various kinds of information relating to surgery. A printer 11208 is an apparatus capable of printing various kinds of information relating to surgery in various forms such as a text, an image or a graph.

It is to be noted that the light source apparatus 11203 which supplies irradiation light when a surgical region is to be imaged to the endoscope 11100 may include a white light source which includes, for example, an LED, a laser light source or a combination of them. Where a white light source includes a combination of red, green, and blue (RGB) laser light sources, since the output intensity and the output timing can be controlled with a high degree of accuracy for each color (each wavelength), adjustment of the white balance of a picked up image can be performed by the light source apparatus 11203. Further, in this case, if laser beams from the respective RGB laser light sources are irradiated time-divisionally on an observation target and driving of the image pickup elements of the camera head 11102 are controlled in synchronism with the irradiation timings. Then images individually corresponding to the R, G and B colors can be also picked up time-divisionally. According to this method, a color image can be obtained even if color filters are not provided for the image pickup element.

Further, the light source apparatus 11203 may be controlled such that the intensity of light to be outputted is changed for each predetermined time. By controlling driving of the image pickup element of the camera head 11102 in synchronism with the timing of the change of the intensity of light to acquire images time-divisionally and synthesizing the images, an image of a high dynamic range free from underexposed blocked up shadows and overexposed highlights can be created.

Further, the light source apparatus 11203 may be configured to supply light of a predetermined wavelength band ready for special light observation. In special light observation, for example, by utilizing the wavelength dependency of absorption of light in a body tissue to irradiate light of a narrow band in comparison with irradiation light upon ordinary observation (namely, white light), narrow band observation (narrow band imaging) of imaging a predetermined tissue such as a blood vessel of a superficial portion of the mucous membrane or the like in a high contrast is performed. Alternatively, in special light observation, fluorescent observation for obtaining an image from fluorescent light generated by irradiation of excitation light may be performed. In fluorescent observation, it is possible to perform observation of fluorescent light from a body tissue by irradiating excitation light on the body tissue (autofluorescence observation) or to obtain a fluorescent light image by locally injecting a reagent such as indocyanine green (ICG) into a body tissue and irradiating excitation light corresponding to a fluorescent light wavelength of the reagent upon the body tissue. The light source apparatus 11203 can be configured to supply such narrow-band light and/or excitation light suitable for special light observation as described above.

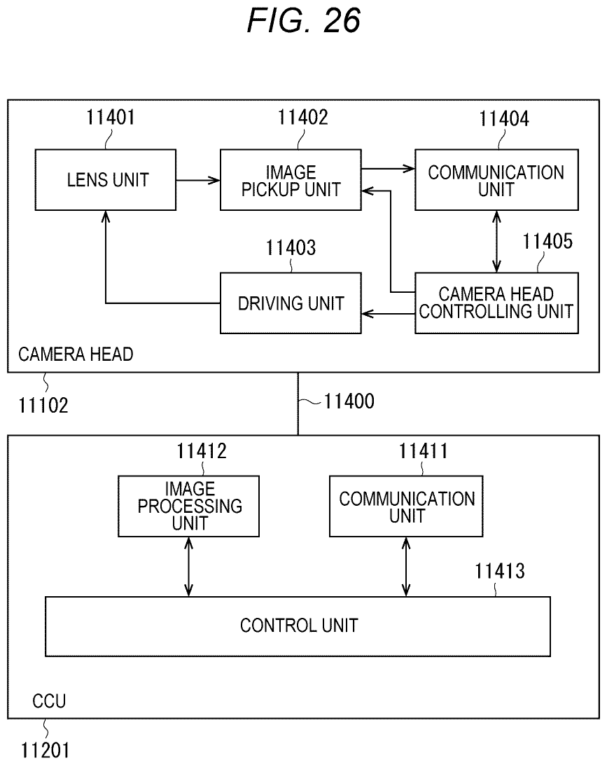

FIG. 26 is a block diagram depicting an example of a functional configuration of the camera head 11102 and the CCU 11201 depicted in FIG. 25.

The camera head 11102 includes a lens unit 11401, an image pickup unit 11402, a driving unit 11403, a communication unit 11404 and a camera head controlling unit 11405. The CCU 11201 includes a communication unit 11411, an image processing unit 11412 and a control unit 11413. The camera head 11102 and the CCU 11201 are connected for communication to each other by a transmission cable 11400.

The lens unit 11401 is an optical system, provided at a connecting location to the lens barrel 11101. Observation light taken in from a distal end of the lens barrel 11101 is guided to the camera head 11102 and introduced into the lens unit 11401. The lens unit 11401 includes a combination of a plurality of lenses including a zoom lens and a focusing lens.

The image pickup unit 11402 includes an image pickup element. The number of image pickup elements which is included by the image pickup unit 11402 may be one (single-plate type) or a plural number (multi-plate type). Where the image pickup unit 11402 is configured as that of the multi-plate type, for example, image signals corresponding to respective R, G and B are generated by the image pickup elements, and the image signals may be synthesized to obtain a color image. The image pickup unit 11402 may also be configured so as to have a pair of image pickup elements for acquiring respective image signals for the right eye and the left eye ready for three dimensional (3D) display. If 3D display is performed, then the depth of a living body tissue in a surgical region can be comprehended more accurately by the surgeon 11131. It is to be noted that, where the image pickup unit 11402 is configured as that of stereoscopic type, a plurality of systems of lens units 11401 are provided corresponding to the individual image pickup elements.

Further, the image pickup unit 11402 may not necessarily be provided on the camera head 11102. For example, the image pickup unit 11402 may be provided immediately behind the objective lens in the inside of the lens barrel 11101.

The driving unit 11403 includes an actuator and moves the zoom lens and the focusing lens of the lens unit 11401 by a predetermined distance along an optical axis under the control of the camera head controlling unit 11405. Consequently, the magnification and the focal point of a picked up image by the image pickup unit 11402 can be adjusted suitably.

The communication unit 11404 includes a communication apparatus for transmitting and receiving various kinds of information to and from the CCU 11201. The communication unit 11404 transmits an image signal acquired from the image pickup unit 11402 as RAW data to the CCU 11201 through the transmission cable 11400.

In addition, the communication unit 11404 receives a control signal for controlling driving of the camera head 11102 from the CCU 11201 and supplies the control signal to the camera head controlling unit 11405. The control signal includes information relating to image pickup conditions such as, for example, information that a frame rate of a picked up image is designated, information that an exposure value upon image picking up is designated and/or information that a magnification and a focal point of a picked up image are designated.

It is to be noted that the image pickup conditions such as the frame rate, exposure value, magnification or focal point may be designated by the user or may be set automatically by the control unit 11413 of the CCU 11201 on the basis of an acquired image signal. In the latter case, an auto exposure (AE) function, an auto focus (AF) function and an auto white balance (AWB) function are incorporated in the endoscope 11100.

The camera head controlling unit 11405 controls driving of the camera head 11102 on the basis of a control signal from the CCU 11201 received through the communication unit 11404.

The communication unit 11411 includes a communication apparatus for transmitting and receiving various kinds of information to and from the camera head 11102. The communication unit 11411 receives an image signal transmitted thereto from the camera head 11102 through the transmission cable 11400.

Further, the communication unit 11411 transmits a control signal for controlling driving of the camera head 11102 to the camera head 11102. The image signal and the control signal can be transmitted by electrical communication, optical communication or the like.

The image processing unit 11412 performs various image processes for an image signal in the form of RAW data transmitted thereto from the camera head 11102.

The control unit 11413 performs various kinds of control relating to image picking up of a surgical region or the like by the endoscope 11100 and display of a picked up image obtained by image picking up of the surgical region or the like. For example, the control unit 11413 creates a control signal for controlling driving of the camera head 11102.

Further, the control unit 11413 controls, on the basis of an image signal for which image processes have been performed by the image processing unit 11412, the display apparatus 11202 to display a picked up image in which the surgical region or the like is imaged. Thereupon, the control unit 11413 may recognize various objects in the picked up image using various image recognition technologies. For example, the control unit 11413 can recognize a surgical tool such as forceps, a particular living body region, bleeding, mist when the energy device 11112 is used and so forth by detecting the shape, color and so forth of edges of objects included in a picked up image. The control unit 11413 may cause, when it controls the display apparatus 11202 to display a picked up image, various kinds of surgery supporting information to be displayed in an overlapping manner with an image of the surgical region using a result of the recognition. Where surgery supporting information is displayed in an overlapping manner and presented to the surgeon 11131, the burden on the surgeon 11131 can be reduced and the surgeon 11131 can proceed with the surgery with certainty.

The transmission cable 11400 which connects the camera head 11102 and the CCU 11201 to each other is an electric signal cable ready for communication of an electric signal, an optical fiber ready for optical communication or a composite cable ready for both of electrical and optical communications.

Here, while, in the example depicted, communication is performed by wired communication using the transmission cable 11400, the communication between the camera head 11102 and the CCU 11201 may be performed by wireless communication.

An example of the endoscopic surgery system to which the technology according to the present disclosure can be applied has been described above. The technology according to the present disclosure can be applied to the lens unit 11401, the image pickup unit 11402, and the like among the above-described configurations. Specifically, the imaging apparatus 10 described above can be applied to the lens unit 11401, the image pickup unit 11402, and the driving unit 11403. By applying the technology according to the present disclosure to the lens unit 11401 and the image pickup unit 11402, it is possible to realize both good imaging quality and a small F-number with a small size and a wide angle. As a result, for example, the surgeon can reliably confirm the surgical region by the wide-angle surgical region image with high image quality and bright.

Note that, here, the endoscopic surgery system has been described as an example, but the technology according to the present disclosure may be applied to, for example, a microscopic surgery system or the like.

### 5. Application Example to Mobile Body

The technology according to the present disclosure (present technology) can be applied to various products. For example, the technology according to the present disclosure may be realized as an apparatus mounted on any type of mobile body such as an automobile, an electric vehicle, a hybrid electric vehicle, a motorcycle, a bicycle, a personal mobility, an airplane, a drone, a ship, and a robot.

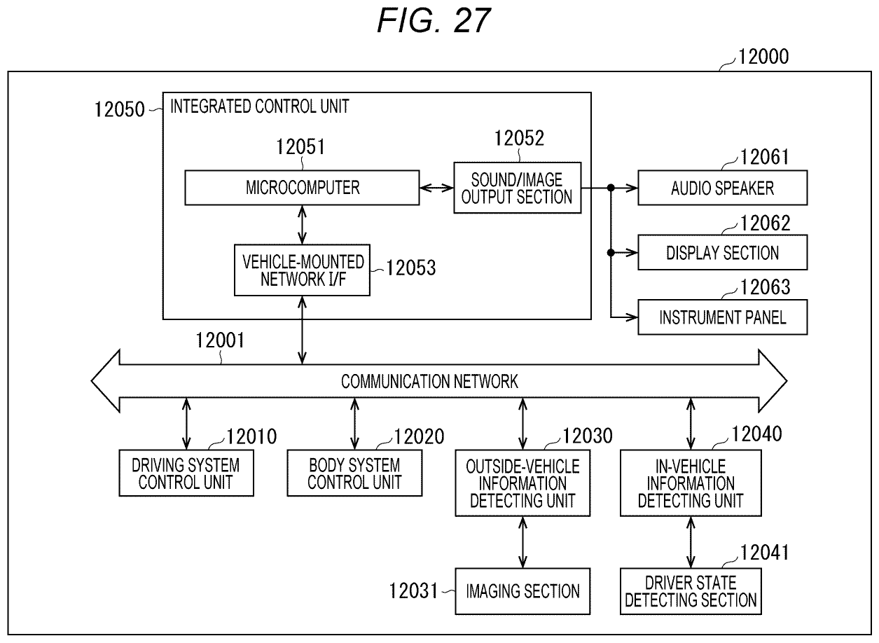

FIG. 27 is a block diagram depicting an example of schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 27, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 27, an audio speaker 12061, a display section 12062, and an instrument panel 12063 are illustrated as the output device. The display section 12062 may, for example, include at least one of an on-board display and a head-up display.

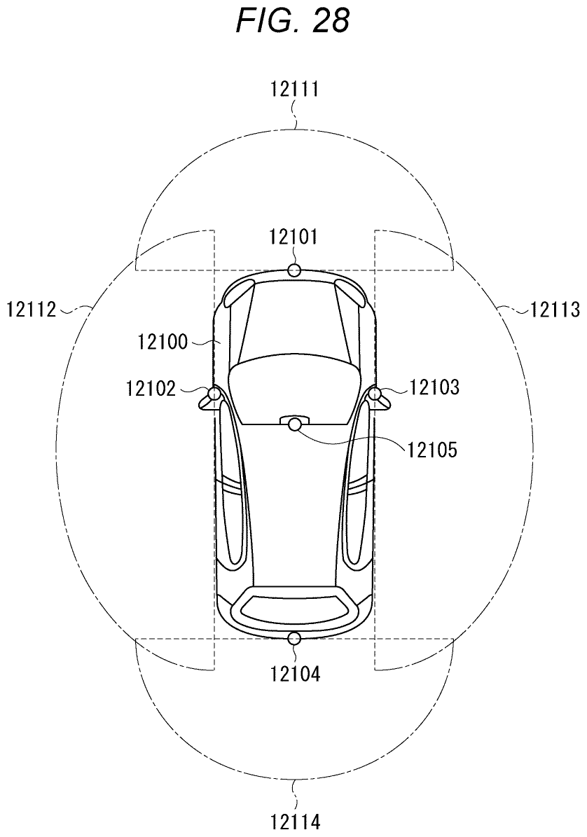

FIG. 28 is a diagram depicting an example of the installation position of the imaging section 12031.

In FIG. 28, the vehicle 12100 includes imaging sections 12101, 12102, 12103, 12104, and 12105 as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The front images acquired by the imaging sections 12101 and 12105 are used mainly to detect a preceding vehicle, a pedestrian, an obstacle, a signal, a traffic sign, a lane, or the like.

Incidentally, FIG. 28 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging section 12031 and the like among the configurations described above. Specifically, the imaging apparatus 10 described above can be applied to the imaging section 12031. By applying the technology according to the present disclosure to the imaging section 12031, both good imaging quality and a small F-number can be realized in a small size and wide angle. As a result, it is possible to obtain a captured image with high image quality and a bright wide angle, and thus, it is possible to improve safety and comfort of the driver, for example.

The embodiments of the present technology are not limited to the above-described embodiments, and various modifications can be made without departing from the gist of the present technology.

The effects described in the present specification are merely examples and are not limited, and effects other than those described in the present specification may be provided.

The present technology can have the following configurations.

(1)

A lens optical system including:
in order from an object side toward an image side,
a first lens group having negative refractive power; and
a second lens group having positive refractive power,
in which
the first lens group includes
a first lens with negative refractive power,
the second lens group includes:
in order from the object side toward the image side,
a second lens having positive refractive power;
a third lens having negative refractive power;
a fourth lens having positive or negative refractive power;
a fifth lens having positive refractive power; and
a sixth lens having negative refractive power,
and
when a focal length of the entire lens optical system is f and a focal length of the second lens group is fa2,
a condition of

$$1 \leq fa 2 / f \leq 2$$

is satisfied.
   (2)

The lens optical system according to (1), in which
when a curvature radius of a surface of the first lens on the object side is R1 and a curvature radius of a surface of the first lens on the image side is R2,
a condition of

$$0.5 \leq ( R 1 + R 2 ) / ( R 1 - R 2 ) \leq 1.1$$

is satisfied.
   (3)

The lens optical system according to (1) or (2), in which
when a viewing angle of the lens optical system is FOV, a total length of the lens optical system is TTL, and a distance between a surface of the first lens on the image side and a surface of the second lens on the object side is D2,
a condition of

$$15 \leq FOV ( D 2 / TTL ) \leq 30$$

is satisfied.
   (4)

The lens optical system according to any one of (1) to (3), in which
when a focal length of the entire lens optical system is f and a focal length of the sixth lens is f6,
a condition of

$$- 4.5 \leq f 6 / f \leq - 1.5$$

is satisfied.
   (5)

The lens optical system according to any one of (1) to (4), in which
when an Abbe number of the second lens at a d-line is Vd2,
a condition of

$$50 \leq Vd 2 \leq 80$$

is satisfied.
   (6)

The lens optical system according to any one of (1) to (5), in which
when an Abbe number of the third lens at a d-line is Vd3,
a condition of

$$15 \leq Vd 3 \leq 30$$

is satisfied.
   (7)

The lens optical system according to any one of (1) to (6), in which
when a principal ray angle of light incident on an imaging surface from the lens optical system is CRA,
a condition of

$$CRA < 40$$

is satisfied.
   (8)

An imaging apparatus including:
a lens optical system including:
in order from an object side toward an image side,
a first lens group having negative refractive power; and
a second lens group having positive refractive power,
in which
the first lens group includes
a first lens with negative refractive power,
the second lens group includes:
in order from the object side toward the image side,
a second lens having positive refractive power;
a third lens having negative refractive power;
a fourth lens having positive or negative refractive power;
a fifth lens having positive refractive power; and
a sixth lens having negative refractive power,
and
when a focal length of the entire lens optical system is f and a focal length of the second lens group is fa2,
a condition of

$$1 \leq fa 2 / f \leq 2$$

is satisfied; and
an imaging element that converts an optical image formed by
the lens optical system into an electrical signal.

### REFERENCE SIGNS LIST

10 Imaging apparatus
21 Solid-state imaging element
25 Lens optical system
31a Imaging surface
71 to 76 Lens
71a, 71b, 72a Surface
171 to 176 Lens
171a, 171b, 172a Surface
271 to 276 Lens
271a, 271b, 272a Surface
371 to 376 Lens
371a, 371b, 372a Surface
471 to 476 Lens
471a, 471b, 472a Surface

1. A lens optical system comprising:
in order from an object side toward an image side,
a first lens group having negative refractive power; and
a second lens group having positive refractive power,
wherein
the first lens group includes
a first lens with negative refractive power,
the second lens group includes:
in order from the object side toward the image side,
a second lens having positive refractive power;
a third lens having negative refractive power;
a fourth lens having positive or negative refractive power;
a fifth lens having positive refractive power; and
a sixth lens having negative refractive power,
and
when a focal length of the entire lens optical system is f and a focal length of the second lens group is fa2,
a condition of
$$1 \leq fa 2 / f \leq 2$$
is satisfied.

2. The lens optical system according to claim 1, wherein
when a curvature radius of a surface of the first lens on the object side is R1 and a curvature radius of a surface of the first lens on the image side is R2,
a condition of
$$0.5 \leq ( R 1 + R 2 ) / ( R 1 - R 2 ) \leq 1.1$$
is satisfied.

3. The lens optical system according to claim 1, wherein
when a viewing angle of the lens optical system is FOV, a total length of the lens optical system is TTL, and a distance between a surface of the first lens on the image side and a surface of the second lens on the object side is D2,
a condition of
$$15 \leq FOV ( D 2 / TTL ) \leq 30$$
is satisfied.

4. The lens optical system according to claim 1, wherein
when a focal length of the entire lens optical system is f and a focal length of the sixth lens is f6,
a condition of
$$- 4.5 \leq f 6 / f \leq - 1.5$$
is satisfied.

5. The lens optical system according to claim 1, wherein
when an Abbe number of the second lens at a d-line is Vd2,
a condition of
$$50 \leq Vd 2 \leq 80$$
is satisfied.

6. The lens optical system according to claim 1, wherein
when an Abbe number of the third lens at a d-line is Vd3,
a condition of
$$15 \leq Vd 3 \leq 30$$
is satisfied.

7. The lens optical system according to claim 1, wherein
when a principal ray angle of light incident on an imaging surface from the lens optical system is CRA,
a condition of
$$CRA < 40$$
is satisfied.

8. An imaging apparatus comprising:
a lens optical system including:
in order from an object side toward an image side,
a first lens group having negative refractive power; and
a second lens group having positive refractive power,
wherein
the first lens group includes
a first lens with negative refractive power,
the second lens group includes:
in order from the object side toward the image side,
a second lens having positive refractive power;
a third lens having negative refractive power;
a fourth lens having positive or negative refractive power;
a fifth lens having positive refractive power; and
a sixth lens having negative refractive power,
and
when a focal length of the entire lens optical system is f and a focal length of the second lens group is fa2,
a condition of
$$1 \leq fa 2 / f \leq 2$$
is satisfied; and
an imaging element that converts an optical image formed by the lens optical system into an electrical signal.
